(19) United States
(12) Patent Application Publication
(10) Pub. No.: US 2010/0177348 A1
(43) Pub. Date: Jul. 15, 2010

(54) PAGE IMAGE MANAGING APPARATUS

(75) Inventor: Junji Yamada, Kanagawa-ken (JP)

Correspondence Address: TUROCY & WATSON, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/686,829

(22) Filed: Jan. 13, 2010

Related U.S. Application Data
(60) Provisional application No. 61/144,984, filed on Jan. 15, 2009.

(51) Int. Cl. G06F 3/12; G06K 15/00

(52) U.S. Cl. 358/1.15; 358/1.18

(57) ABSTRACT

The present invention provides a page image managing technique that enables editing of N-in-1-arranged page images. A page image managing apparatus includes: a number-of-pages-information acquiring unit configured to acquire number-of-input-pages information indicating the number of arrayed pages of plural page images arrayed in a reading target original document; an image processing unit configured to slice, on the basis of the number-of-input-pages information acquired by the number-of-pages-information acquiring unit, the plural page images from a read image of the original document and apply image processing corresponding to the number-of-input-pages information acquired by the number-of-pages-information acquiring unit to the respective sliced page images; and a storage control unit configured to cause a predetermined storage area to store the respective plural page images processed by the image processing unit as separate page images.

### CROSS-REFERENCE TO RELATED APPLICATION

This application is based upon and claims the benefit of priority from: US provisional application 61/144,984, filed on Jan. 15, 2009; the entire contents of each of which are incorporated herein by reference.

### TECHNICAL FIELD

The present invention relates to a page image managing apparatus, and, more particularly to an image managing technique capable of editing an array of page images arrayed by N-in-1 arrangement processing.

### BACKGROUND

In the past, in an apparatus such as a digital multi function peripheral (MFP), there is known N-in-1 arrangement processing for reducing the size of plural images (page images) and arraying the plural images in one image to form an output image to thereby output the plural images as one consolidated output image.

Several techniques concerning editing of an array of page images in an image generated by applying the N-in-1 arrangement processing are also proposed.

For example, there is proposed a technique for applying division to an image subjected to the N-in-1 arrangement processing and outputting respective page images according to the order of arranging the respective page images (e.g., the order of page numbers) (JP-A-2007-235885).

However, in some cases, a page image that a user does not desire to output is included in the image subjected to the N-in-1 arrangement processing. In the past, no technique is proposed that is capable of performing, in such a case, editing processing for generating an output image excluding the page image that is not desired to be output or changing a component scaling factor of the page images in the output image in the generation of the output image excluding the page image as a part of the page images.

### SUMMARY

In order to solve the problems, for example, image processing corresponding to the number of arrayed pages of an original document maybe applied to plural page images sliced from the original document.

According to an aspect of the present invention, there is provided a page image managing apparatus including: a number-of-pages-information acquiring unit configured to acquire number-of-input-pages information indicating the number of arrayed pages of plural page images arrayed in a reading target original document; an image processing unit configured to slice, on the basis of the number-of-input-pages information acquired by the number-of-pages-information acquiring unit, the plural page images from a read image of the original document and apply image processing corresponding to the number-of-input-pages information acquired by the number-of-pages-information acquiring unit to the respective sliced page images; and a storage control unit configured to cause a predetermined storage area to store the respective plural page images processed by the image processing unit as separate page images.

Image processing corresponding to the number of arranged pages of an original document and assumed editing content may be applied to plural page images sliced from the original document.

According to another aspect of the present invention, there is provided a page image managing apparatus including: a number-of-pages-information acquiring unit configured to acquire number-of-input-pages information indicating the number of arrayed pages of plural page images arrayed in a reading target original document; a size-change-information acquiring unit configured to acquire, on the basis of operation input of a user, interim size change information concerning size change processing assumed to be applied to page images stored in a predetermined storage area; an image processing unit configured to slice, on the basis of the number-of-input-pages information acquired by the number-of-pages-information acquiring unit, the plural page images from a read image of the original document and apply image processing corresponding to the number-of-input-pages information acquired by the number-of-pages-information acquiring unit and the interim size change information acquired by the size-change-information acquiring unit to the respective sliced page images; and a storage control unit configured to cause the predetermined storage area to store the respective plural page images processed by the image processing unit as separate page images.

Image processing corresponding to the number of arranged pages of an original document may be applied to an image obtained by editing separate page images.

According to still another aspect of the present invention, there is provided an image managing apparatus including: a number-of-pages-information acquiring unit configured to acquire number-of-input-pages information indicating the number of arrayed pages of editing target plural page images in an original document on which the plural page images are arrayed; an editing processing unit configured to apply editing processing including size change processing based on operation input of a user to the plural page images sliced from a read image of the original document and stored in a predetermined storage area; and an image correcting unit configured to apply image processing corresponding to the number-of-input-pages information acquired by the number-of-pages-information acquiring unit and the size change processing applied by the editing processing unit to the page images subjected to the editing processing by the editing processing unit.

Image processing corresponding to the number of arranged pages of an original document may be separately applied to respective plural page images on a read image of the original document without slicing the plural page images.

According to still another aspect of the present invention, there is provide a page image managing apparatus including: a number-of-pages-information acquiring unit configured to acquire number-of-input-pages information indicating the number of arrayed pages of plural page images arrayed in a reading target original document; an image processing unit configured to apply, on the basis of the number-of-input-pages information acquired by the number-of-pages-information acquiring unit, image processing corresponding to the number-of-input-pages information acquired by the number-of-pages-information acquiring unit to image areas corresponding to the respective plural page images on a read image of the original document; and a storage control unit configured to cause a predetermined storage area to store the image areas corresponding to the respective plural page images processed by the image processing unit as separate page images.

Image processing corresponding to the number of arranged pages and assumed editing content may be separately applied to respective plural page images on a read image of an original document without slicing the plural page images.

According to still another aspect of the present invention, there is provided a page image managing apparatus including: a number-of-pages-information acquiring unit configured to acquire number-of-input-pages information indicating the number of arrayed pages of plural page images arrayed in a reading target original document; a size-change-information acquiring unit configured to acquire, on the basis of operation input of a user, interim size change information concerning size change processing assumed to be applied to page images stored in a predetermined storage area; an image processing unit configured to apply image processing corresponding to the number-of-input-pages information acquired by the number-of-pages-information acquiring unit and the interim size information acquired by the size-change-information acquiring unit to image areas corresponding to the respective plural page images on a read image of the original document; and a storage control unit configured to cause the predetermined storage area to store the image areas corresponding to the respective plural page images processed by the image processing unit as separate page images.

Image reading corresponding to the number of arranged pages of an original document may be performed when plural page images on the original document is read.

According to still another aspect of the present invention, there is provided a page image managing apparatus including: a number-of-pages-information acquiring unit configured to acquire number-of-input-pages information indicating the number of arrayed pages of plural page images arrayed in a reading target original document; a scan control unit configured to cause an image reading unit to read, on the basis of the number-of-input-pages information acquired by the number-of-pages-information acquiring unit, in reading the original document, image areas corresponding to the respective plural page images on a read image of the original document in a state in which an image reading condition corresponding to the number-of-input-pages information acquired by the number-of-pages-information acquiring unit is applied to the reading; an image processing unit configured to slice, on the basis of the number-of-input-pages information acquired by the number-of-pages-information acquiring unit, the plural page images from the read image that the image reading unit is caused to read from the original document by the scan control unit and apply image processing corresponding to the number-of-input-pages information acquired by the number-of-pages-information acquiring unit to the respective sliced plural page images; and a storage control unit configured to cause a predetermined storage area to store the plural page images processed by the image processing unit as separate page images.

Image reading corresponding to the number of arranged pages of an original document and assumed editing content may be performed when plural page images on the original document are read.

According to still another aspect of the present invention, there is provided a page image managing apparatus including: a number-of-pages-information acquiring unit configured to acquire number-of-input-pages information indicating the number of arrayed pages of plural page images arrayed in a reading target original document; a size-change-information acquiring unit configured to acquire, on the basis of operation input of a user, interim size change information concerning size change processing assumed to be applied to page images stored in a predetermined storage area; a scan control unit configured to cause an image reading unit to read, in reading the original document, image areas corresponding to the respective plural page images on a read image of the original document in a state in which an image reading condition corresponding to the number-of-input-pages information acquired by the number-of-pages-information acquiring unit and the interim size change information acquired by the size-change-information acquiring unit is applied to the reading; an image processing unit configured to slice, on the basis of the number-of-input-pages information acquired by the number-of-pages-information acquiring unit, the plural page images from the read image that the image reading unit is caused to read from the original document by the scan control unit and apply image processing corresponding to the number-of-input-pages information acquired by the number-of-pages-information acquiring unit and the interim size change information acquired by the size-change-information acquiring unit to the respective sliced plural page images; and a storage control unit configured to cause a predetermined storage area to store the plural page images processed by the image processing unit as separate page images.

When N-in-1-arranged page images are arranged in plural pages and the number of page images is smaller than a predetermined number in any one of the plural pages, page images corresponding to the page may be moved to a page adjacent thereto.

According to still another aspect of the present invention, there is provided a page image managing apparatus including: an image-information acquiring unit configured to acquire information concerning plural page images set as targets of N-in-1 arrangement; a number-of-arranged-page-images-information acquiring unit configured to acquire information concerning the number of arranged page images indicating how many of the plural page images as the arrangement targets are arranged per one page; and an arrangement control unit configured to N-in-1-arrange the plural page images acquired by the image-information acquiring unit according to the information concerning the number of arranged page images acquired by the number-of-arranged-page-images-information acquiring unit and move, when there is a page in which the number of page images per one page is smaller than a predetermined number, an excess page image corresponding to the page, in which the number of page images is smaller than the predetermined number, to a page having a page number adjacent to a page number of the page.

### DESCRIPTION OF THE DRAWINGS

FIG. 1 is a perspective view of the schematic configuration of an image managing apparatus according to a first embodiment of the present invention;

FIG. 2 is a functional block diagram related to storage of page images and editing processing for an output image by a MFP 101 according to the first embodiment;

FIG. 3 is an illustrative diagram of images of a reading target original document according to the first embodiment;

FIG. 4 is an illustrative diagram of an input screen for requesting the start of storage of page images and editing processing for an output image according to the first embodiment;

FIG. 5 is an illustrative diagram of an input screen for acquiring number-of-input-page-images information according to the first embodiment;

FIG. 6 is an illustrative diagram of a display screen for displaying information concerning page images stored in a memory 802 according to the first embodiment;

FIG. 7 is an illustrative diagram of an output image setting screen for acquiring N-in-1 arrangement information and output sheet size information according to the first embodiment;

FIG. 8 is an illustrative diagram of an output image according to the first embodiment;

FIG. 9 is a flowchart for explaining a processing flow concerning recording of page images according to the first embodiment;

FIG. 10 is a flowchart for explaining a processing flow concerning editing of an output image according to the first embodiment;

FIG. 11 is a flowchart for explaining a processing flow of image processing for page images according to the first embodiment;

FIG. 12 is a functional block diagram related to storage of page images and editing processing for an output image by the MFP 101 according to a second embodiment of the present invention;

FIG. 13 is a flowchart for explaining a processing flow concerning recording of page images according to the second embodiment;

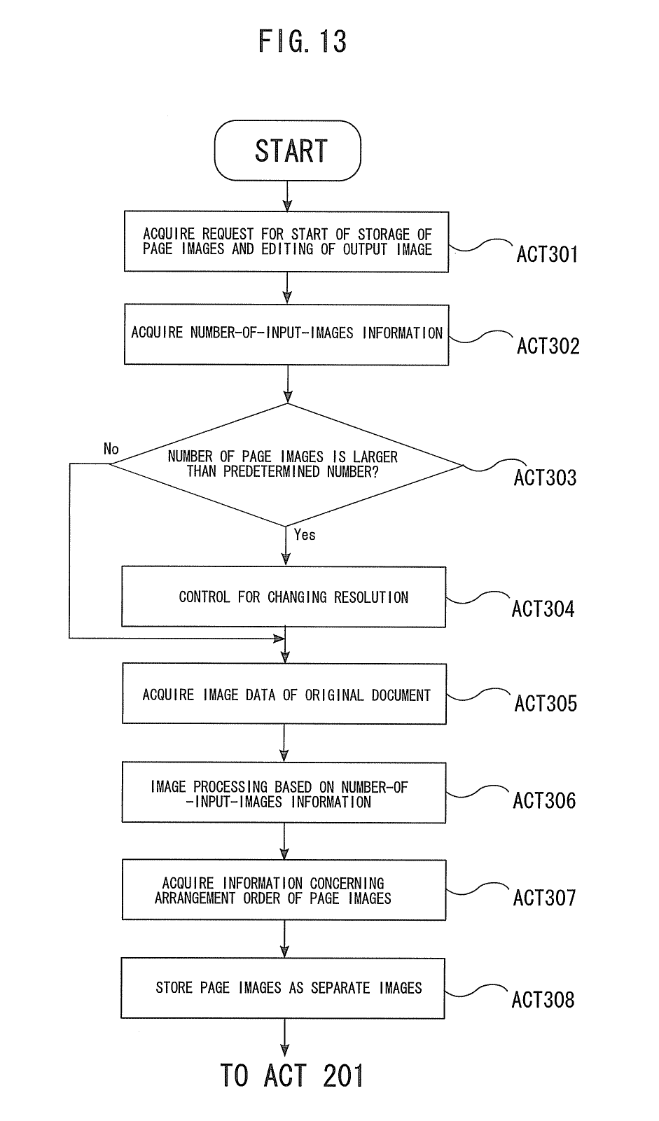

FIG. 14 is a functional block diagram related to processing for moving an excess page image to the preceding page by the MFP 101 according to a third embodiment of the present invention;

FIG. 15 is an illustrative diagram of plural output images including an excess page image according to the third embodiment;

FIG. 16 is an illustrative diagram of the plural output images in which the excess page image is rotated and moved to the preceding page according to the third embodiment;

FIG. 17 is an illustrative diagram of the plural output images in which the excess page image is moved to the preceding page without being rotated according to the third embodiment;

FIG. 18 is a flowchart for explaining a processing flow concerning movement of the excess page image to the preceding page according to the third embodiment;

FIG. 19 is a functional block diagram related to processing for moving an excess page image to the preceding page by the MFP 101 according to a fourth embodiment of the present invention;

FIG. 20 is an illustrative diagram of a moving page image selection screen on which a page to be moved other than the excess page image can be selected according to the fourth embodiment;

FIG. 21 is an illustrative diagram of plural output images in which the excess page image is rotated and moved to the preceding page according to the fourth embodiment;

FIG. 22 is an illustrative diagram of the plural output images in which the excess page image is moved to the preceding page without being rotated according to the fourth embodiment;

FIG. 23 is a flowchart for explaining a processing flow concerning movement of the excess page image to the preceding page according to the fourth embodiment;

FIG. 24 is a functional block diagram related to storage of page images and editing processing for an output image by the MFP 101 according to another embodiment of the present invention; and

FIG. 25 is an illustrative diagram of an input screen for acquiring number-of-input-pages information and interim size change information according to the other embodiment.

### DETAILED DESCRIPTION

Embodiments of the present invention are explained below with reference to the accompanying drawings.

### First Embodiment

First, a first embodiment of the present invention is explained.

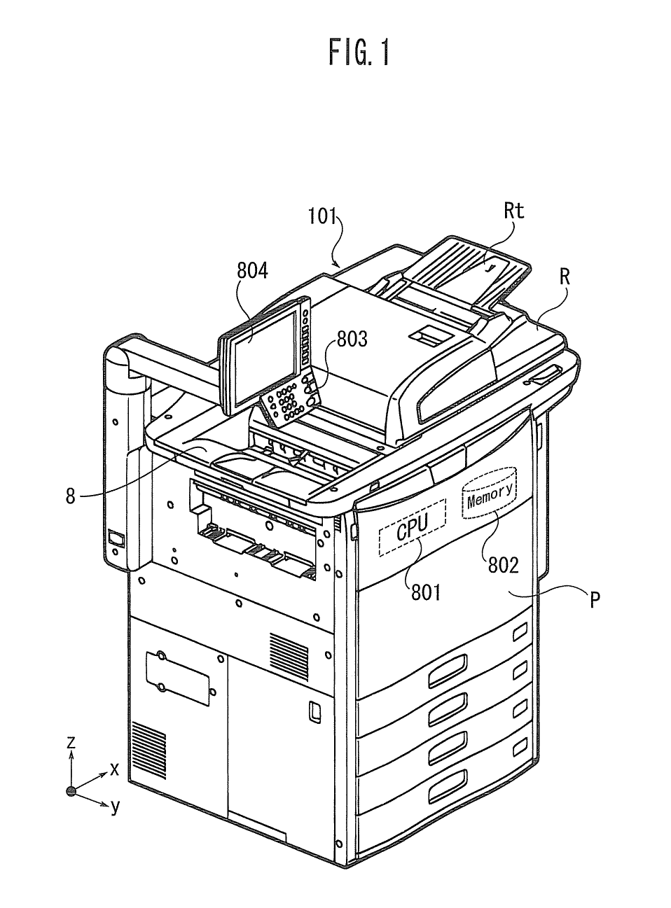

FIG. 1 is a perspective view of the schematic configuration of a MFP (multi function peripheral, equivalent to an image managing apparatus) 101 according to the first embodiment. The MFP 101 according to the first embodiment includes an ADF (auto document feeder) Ra, an image reading unit R, an image forming unit P, and a discharge tray 8.

The ADF Ra has a function of automatically continuously conveying plural original documents placed on a tray Rt to a predetermined document reading position for reading by the image reading unit R.

The image reading unit R is arranged above an image forming apparatus main body and has a function of scanning and reading images of a sheet document automatically conveyed by the ADF Ra and a sheet document or a book document placed on a not-shown document placing table.

The image forming unit P has a function of forming a developer image on a sheet fed from a paper feeding cassette K on the basis of an image read from an original document by the image reading unit R, image data received from an external apparatus by the MFP 101, or the like.

The sheet on which the image is formed by the image forming unit P is discharged onto the discharge tray 8.

The MFP 101 according to the first embodiment further includes a CPU 801 and a memory 802.

The CPU 801 has a role of performing various kinds of processing in the MFP 101 and also has a role of realizing various functions by executing a computer program stored in the memory 802.

The memory 802 can include a RAM (Random Access Memory), a ROM (Read Only Memory), a DRAM (Dynamic Random Access Memory), an SRAM (Static Random Access Memory), or a VRAM (Video RAM). The memory 802 has a role of storing various kinds of information and computer programs used in the MFP 101.

As shown in FIG. 1, the MFP 101 includes a display 803 and an operation unit 804 including a graphical display mounted with a touch panel sensor, dedicated buttons frequently used for, for example, inputting numerical values, starting processing, and canceling processing, and a state display LED. Further, the MFP 101 includes standard components such as a scanner, a printer, a network interface for performing communication with the outside through a network, and an external apparatus interface (e.g., a USB interface) for performing communication with external apparatuses.

Therefore, the MFP 101 can execute, through the network or on the basis of a request from a user acquired via the operation unit 804, an application program stored in a storage area of the memory 802 or the like and execute processing such as monochrome or color copying, monochrome or color scanning, and monochrome or color printing.

The MFP 101 according to the first embodiment can acquire image data from an original document subjected to N-in-1 arrangement processing and acquire plural page images included in a read image of the original document as separate images. The MFP 101 can select at least one of the page images acquired as the separate images and N-in-1-arrange and output the page images. The MFP 101 can change (increase), in N-in-1-arranging and outputting the page images acquired as the separate images, a component scaling factor thereof in an output image to a component scaling factor for the page images in the image of the original document and output the page images. First, the CPU 801 executes image processing on image data of the image of the original document read by the image reading unit R. Subsequently, the CPU 801 causes the memory 802 to store the plural page images included in the image of the original document as the separate images on the basis of the image data of the original document subjected to image processing. The CPU 801 applies image processing to at least one of the separate page images stored in the memory 802 and generates an output image from the page image subjected to the image processing. The generated output image is output onto a sheet by, for example, the image forming unit P.

In this specification, the page image means a reduced image arranged in the image of the original document.

Number-of-page-images information of page images to be N-in-1-arranged, information concerning arrangement positions in the image, and information concerning arrangement order in the image are stored in the memory 802 in advance in association with one another.

Functional blocks concerning storage of page images and editing of an output image in the MFP 101 according to the first embodiment are explained below.

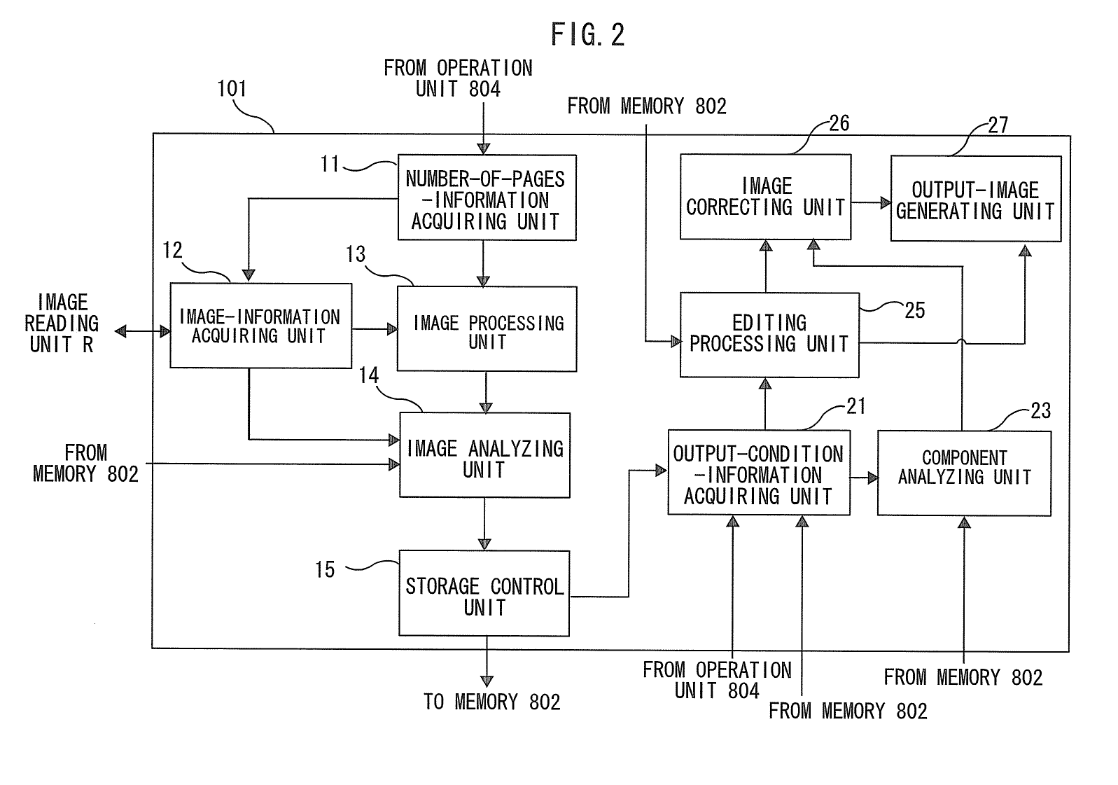

As shown in FIG. 2, the MFP 101 according to the first embodiment includes a number-of-pages-information acquiring unit 11, an image-information acquiring unit 12, an image processing unit 13, a storage control unit 15, an editing-content acquiring unit 21, a component analyzing unit 23, an editing processing unit 25, an image correcting unit 26, and an output-image generating unit 27.

The number-of-pages-information acquiring unit 11 acquires number-of-input-pages information indicating the number of arrayed pages of plural page images arrayed in a reading target original document.

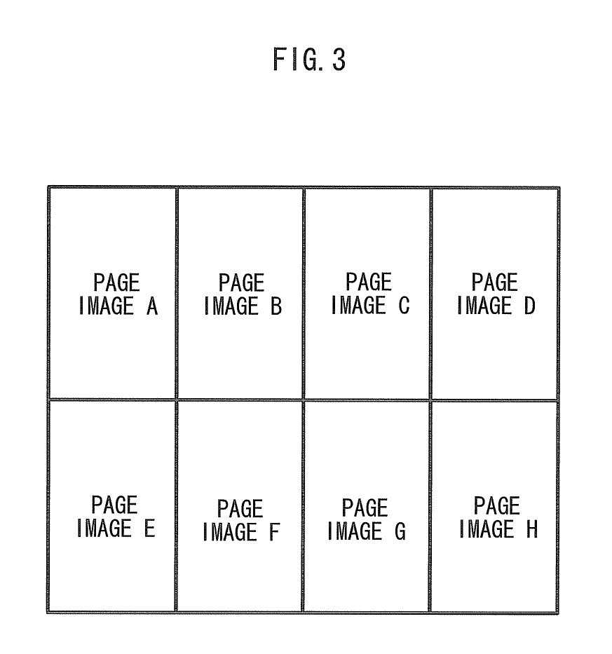

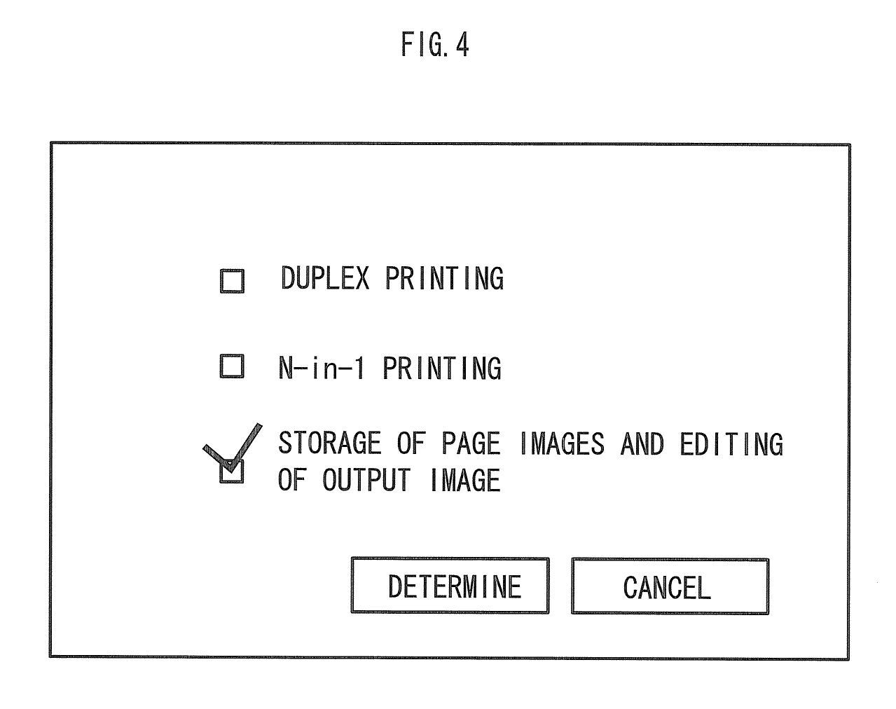

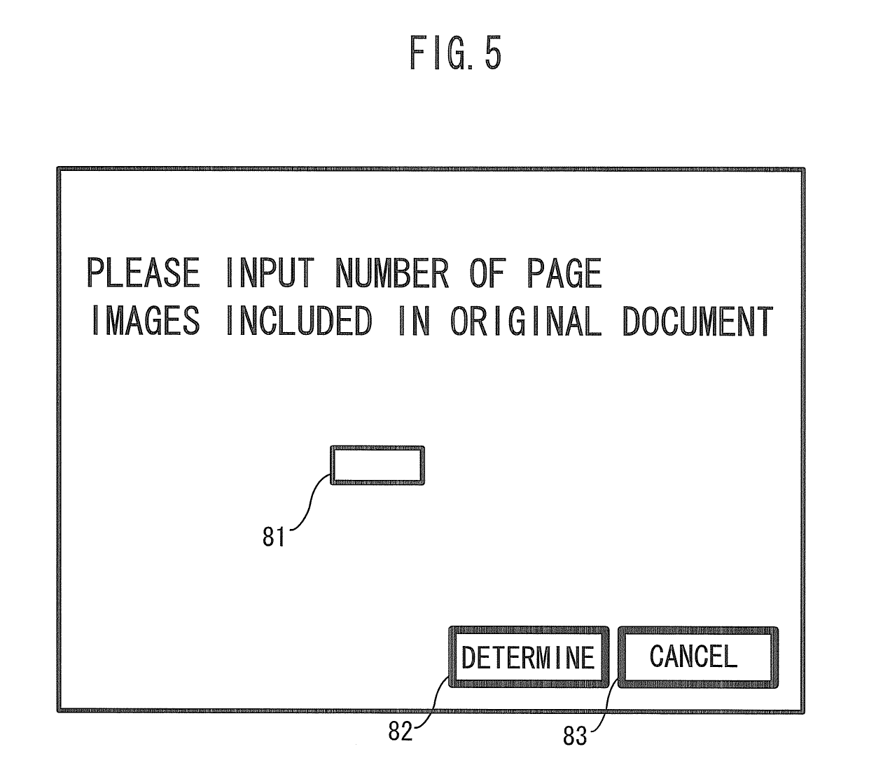

For example, editing processing applied to an image of an original document including eight page images A to H shown in FIG. 3 is explained. The number-of-pages-information acquiring unit 11 acquires, from the user, a request for start of storage of page images and editing of an output image via an input screen for requesting the start of predetermined processing shown in FIG. 4. The input screen is formed by the CPU 801 and displayed on the display 803. The number-of-pages-information acquiring unit 11, which acquires the request for start of storage of page images and editing of an output image, forms an input screen for the number of page images shown in FIG. 5 and causes the display 803 to display the input screen. Subsequently, the number-of-pages-information acquiring unit 11 acquires the number of page images included in the original document as number-of-input-pages information using the input screen for the number of page images. In the input screen shown in FIG. 5, the user inputs the number of page images in an input space 81 in the input screen and depresses a button 82 to cause the number-of-pages information acquiring unit 11 to execute input of the number of page images. A button 83 is a button for canceling the storage of page images and the editing processing for an output image.

The number-of-pages information acquiring unit 11 sends the acquired number-of-input-pages information to the image processing unit 13. The number-of-pages-information acquiring unit 11 notifies the image-information acquiring unit 12 that the request for start of storage of page images and editing of an output image is acquired.

The image acquiring unit 12 acquires, on the basis of the notification that the request for start of storage of page images and editing of an output image is acquired, the image data of the original document from the image reading unit R and sends the image data to the image processing unit 13 and the image analyzing unit 14.

The image processing unit 13 acquires the image data of the original document from the scan control unit 12. Subsequently, the image processing unit 13 slices, on the basis of the number-of-input-pages information acquired by the number-of-pages-information acquiring unit 11, the plural page images from the read image of the original document and applies image processing corresponding to the number-of-input-pages information acquired by the number-of-pages-information acquiring unit 11 to the respective sliced page images.

As specific image processing by the image processing unit 13, for example, base processing for replacing a color of a background of the read image into white or the like and improving visibility of characters and figures, edge detection processing, filter processing, γ correction processing, histogram processing, identification processing, and isolated point removal processing can be performed. In the first embodiment, intensities of the respective kinds of image processing can be set according to the number-of-input-pages information. For example, the intensity of the image processing is set higher to improve an image as the number of page images indicated by the number-of-input-pages information increases.

Since the image processing is applied to the respective plural page images in this way, even when the page images are expanded for later generation of an output image, it is possible to prevent deterioration in attractiveness of the page images due to an increase in size of images of foreign matters and the like.

The image processing unit 13 sends the image data of the original document subjected to the image processing to the image analyzing unit 14 together with the number-of-input-pages information.

The image analyzing unit 14 acquires information concerning arrangement order of the input page images from each input page image, the read image of the original document, and the information concerning arrangement positions in the image and the information concerning arrangement order in the image stored in the memory 802 in association with the number-of-pages information of page images to be N-in-1-arranged. Subsequently, the image analyzing unit 14 sends the acquired information concerning arrangement order in the input page images, the number-of-input-pages information, and the page images to the storage control unit 15.

The storage control unit 15 causes a predetermined storage area, for example, the memory 802 to store the respective plural page images processed by the image processing unit 13 as separate page images. The storage control unit 15 causes the memory 802 to store the information concerning arrangement order of the page images, the number-of-input-pages information, and the page images in association with one another.

The storage control unit 15 sends notification for notifying that the respective plural page images are stored in the memory 802 as the separate page images to the editing-content acquiring unit 21.

The editing-content acquiring unit 21 acquires editing content information indicating editing content in generating an N-in-1-arranged output image from at least one of the page images stored in the memory 802 by the storage control unit 15.

In the first embodiment, the editing-content acquiring unit 21 acquires, as the editing content information, page image specifying information for specifying page images to be N-in-1-arranged in an output image, information concerning the number of page images to be N-in-1-arranged in the output image, N-in-1 arrangement information concerning N-in-1 arrangement of the page images in the output image, output sheet size information concerning the size of a sheet onto which the output image is output, and information concerning arrangement order of pages.

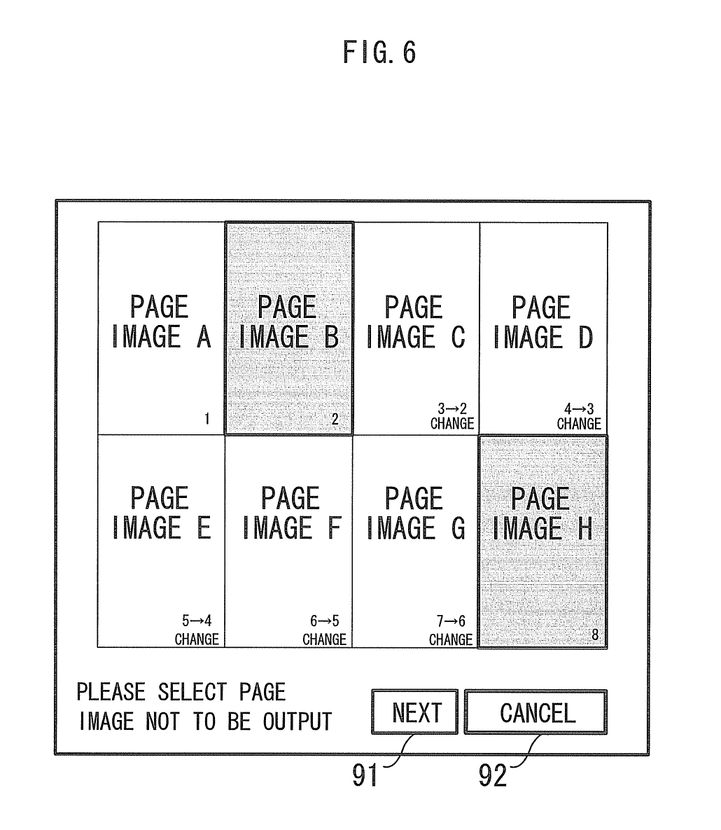

Specifically, first, the editing-content acquiring unit 21 acquires, from the storage control unit 15, the notification for notifying that the respectively plural page images are stored in the memory 802 as the separate images. The editing-content acquiring unit 21 forms, using the page images stored in the memory 802 and the information concerning arrangement order of the page images, thumbnail images of the page images. Subsequently, the editing-content acquiring unit 21 presents the thumbnail images and page image numbers indicating arrangement order of the page images to the user, forms a page image display screen shown in FIG. 6 for allowing the user to select undesired page images, and causes the display 803 to display the page image display screen. In FIG. 6, the user selects images that the user does not desire to output, depresses a button 91, and inputs the selection. As the selection, for example, the user may designate and select page image numbers corresponding to the images that the user does not desire to output among the displayed page image numbers. The user may touch the thumbnail images on the touch panel to select page images. In FIG. 6, the thumbnail images of the page images selected as not desired to be output are displayed with, for example, hatching on the page image display screen displayed on the display 803. When some of the images are selected as not desired to be output, concerning the other image desired to be output, a change in the page image numbers is displayed as shown in FIG. 6. In FIG. 6, a button 92 is a button for canceling the output of the page images.

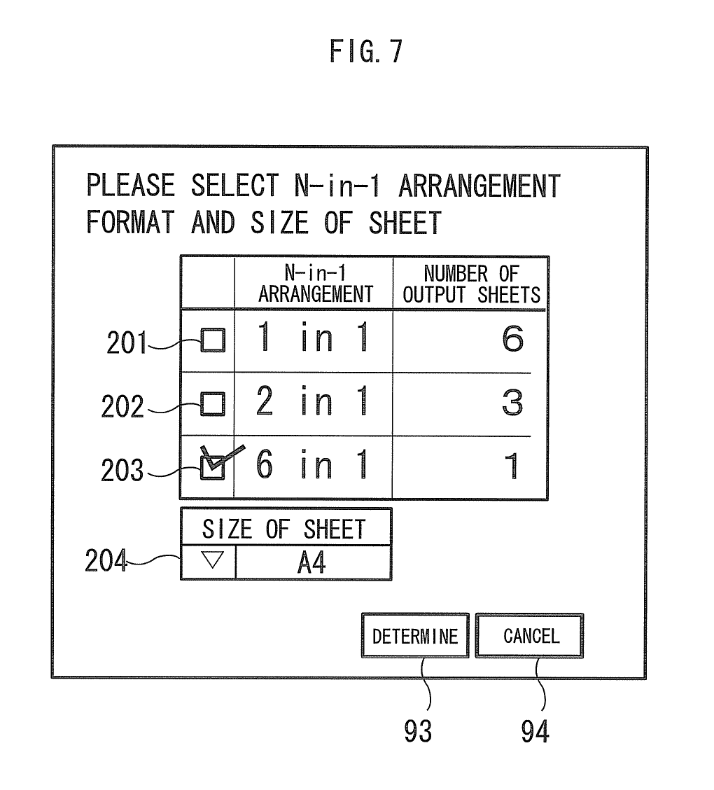

The user inputs, through the page image display screen shown in FIG. 6, the selection concerning the page images that the user does not desire to output. Therefore, the editing-content acquiring unit 21 can acquire page image specifying information for specifying page images to be output, number-of-output-page-images information as information concerning the number of the page images, and information concerning changed or maintained arrangement order of the page images. When the editing-content acquiring unit 21 acquires the page image specifying information, the number-of-output-page-images information, and the information concerning arrangement order of the page information, the editing-content acquiring unit 21 forms an output image setting screen for acquiring the N-in-1 arrangement information concerning N-in-1 arrangement in an output image and the output sheet size information concerning the size of a sheet onto which the output image is output and causes the display 803 to display the output image setting screen. The output image setting screen is illustrated in FIG. 7. As it is understood from FIG. 7, the structure of the output image setting screen is determined on the basis of the number-of-output-page-images information acquired by the editing-content acquiring unit 21. In other words, the editing-content acquiring unit 21 forms the output image setting screen on the basis of the acquired number-of-output-page-images information.

The output image setting screen formed when, for example, the number-of-output-page-images information acquired via the page image display screen shown in FIG. 6 is information indicating that the number of page images is six is explained below. The editing-content acquiring unit 21 forms the output image setting screen to allow the user to select any one of 1-in-1 output, 2-in-1 output, 3-in-1 output, and 6-in-1 output. The editing-content acquiring unit 21 displays the number of sheets onto which page images are output in a format of N-in-1 arrangement. Specifically, when the page images are output in 1-in-1 arrangement, the editing-content acquiring unit 21 displays an indication that each of the page images are output to one sheet. When the page images are output in 2-in-1 arrangement, the editing-content acquiring unit 21 displays an indication that two of the page images are arranged on one sheet and output. When the page images are output in 3-in-1 arrangement, the editing-content acquiring unit 21 displays an indication that three of the page images are arranged on one sheet and output. When the page images are output in 6-in-1 arrangement, the editing-content acquiring unit 21 displays an indication that six of the page images are arranged on one sheet and output.

The user checks any one of check boxes 201 to 203 to select a format of N-in-1 arrangement. The user operates a list box 204 to thereby select the size of a sheet onto which an output image is output. The user depresses a button 93 to perform input concerning selection of the N-in-1 arrangement format and the size of a sheet. The editing-content acquiring unit 21 acquires N-in-1 arrangement information and information concerning the size of a sheet on the basis of the input. In FIG. 7, a button 94 is a button for canceling the output of page images.

The editing-content acquiring unit 21 sends editing content information acquired as explained above to the component analyzing unit 23 and the editing processing unit 25.

The component analyzing unit 23 executes analysis on components included in at least one output page image and acquires information concerning the components.

Specifically, the component analyzing unit 23 acquires, on the basis of the acquired editing content information (more specifically, the page image specifying information), image data of output page images from the memory 802. Subsequently, the component analyzing unit 23 executes analysis of components on the acquired page images and acquires information concerning the components of the page images. For example, when a page image includes only characters as components, the component analyzing unit 23 acquires a font, arrangement, and the like of the characters included in the page image as information concerning the components. When a page image includes figures as components other than characters, the component analyzing unit 23 acquires information concerning shapes, sizes, arrangement, and the like of the figures as information concerning the components in addition to the information concerning a font, arrangement, and the like of the characters.

Subsequently, the component analyzing unit 23 sends the acquired information concerning the components to the image correcting unit 26.

The editing processing unit 25 acquires, on the basis of the acquired editing content information (more specifically, the page image specifying information), the image data of the output page images and the number-of-input-pages information from the memory 802. Subsequently, the editing processing unit 25 applies image processing including size change processing, for example, expansion processing to the acquired image data of the page images. The editing processing unit 25 executes the expansion processing on the page images on the basis of the number-of-output-page-images information, the N-in-1 arrangement information, the output sheet size information, and the number-of-input-pages information. The expansion processing is executed when these kinds of information indicate that the number of output page images is smaller than the number of page images input and stored in the memory 802 or N-in-1 arrangement in an output image is different from N-in-1 arrangement in a document image. The editing processing unit 25 determines whether the expansion processing should be applied to the page images.

The editing processing unit 25 sends the page images subjected to the image processing including the expansion processing to the image correcting unit 26 together with the number-of-input-pages information and the editing content information.

The image correcting unit 26 applies image processing to the page images subjected to, for example, the expansion processing by the editing processing unit 25 according to the number-of-input-pages information, the expansion processing applied by the editing processing unit 25 (in other words, the expansion processing applied by the editing processing unit 25 on the basis of the editing content information), and the information concerning components.

Specifically, if it is determined on the basis of the editing content information that the expansion processing is performed by the editing processing unit 25, the image correcting unit 26 applies the image processing to the components included in the page images. For example, if it is recognized that characters are included in the page image according to the information concerning components, the image correcting unit 26 performs smoothing processing for the characters included in the page images. If it is recognized that figures are included in the page images according to the information concerning components, the image correcting unit 26 executes the expansion processing for the page images and performs edge enhancement. The image correcting unit 26 can specify a rate of the expansion processing in the editing processing unit 25 on the basis of the number-of-input-pages information, the number-of-output-page-images information, and the output sheet size information and apply the image processing at intensity corresponding to the rate.

Even when the page images are expanded and output by such image processing by the editing processing unit 25, it is possible to suppress shapes of characters and figures from being deformed according to the expansion processing.

The image correcting unit 26 sends the page images subjected to the image processing to the output-image generating unit 27 together with editing content information.

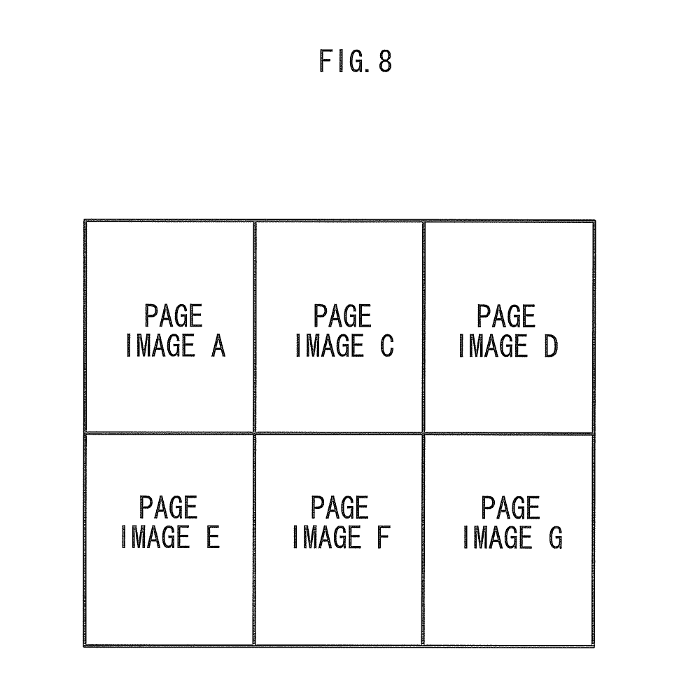

The output-image generating unit 27 generates, on the basis of the editing content information, an output image from the page images subjected to the image processing acquired from the image correcting unit 26. For example, the editing content information (more specifically, the N-in-1 arrangement information) indicates that the acquired page images (a page image A and page images C to G) are 6-in-1-arranged in an output image. The output-image generating unit 27 calculates, on the basis of the information concerning arrangement order of page images included in the editing content information, positions where the page images are arranged. Subsequently, the output-image generating unit 27 combines the page images arranged in the respective positions to thereby generate an output image shown in FIG. 8. The output image generated by the output-image generating unit 27 is output onto a sheet by the image forming unit P in the same manner as in, for example, normal copy processing in the MFP 101.

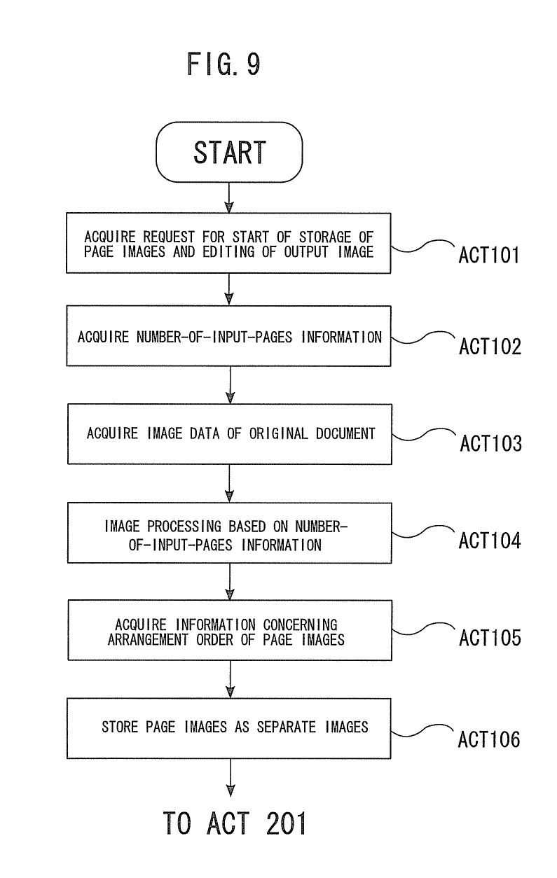

A processing flow for storing plural page images included in an original document as separate images is explained in detail with reference to FIG. 9.

First, in Act 101, the number-of-pages-information acquiring unit 11 acquires a request for the start of storage of page images and editing processing for an output image. Subsequently, in Act 102, the number-of-pages-information acquiring unit 11 forms the input screen for the number of page images shown in FIG. 5 and causes the display 803 to display the input screen. The number-of-pages-information acquiring unit 11 acquires, via the input screen for the number of page images, number-of-input-pages information indicating the number of arrayed pages of plural page images arrayed on a reading target original document. The number-of-pages-information acquiring unit 11 sends the acquired number-of-input-pages information to the image processing unit 13. The number-of-pages-information acquiring unit 11 notifies the image-information acquiring unit 12 that the request for the start of storage of page images and editing processing for an output image is acquired.

In Act 103, the image-information acquiring unit 12 acquires image data of the original document from the image reading unit R and sends the image data to the image processing unit 13 and the image analyzing unit 14. In Act 104, the image processing unit 13 slices, on the basis of the acquired number-of-input-pages information, the plural page images from a read image of the original document and applies image processing corresponding to the number-of-input-pages information acquired by the number-of-pages-information acquiring unit to the respective sliced page images. The image processing unit 13 sends the page images sliced and subjected to the image processing to the image analyzing unit 14 together with the number-of-input-pages information.

In Act 105, the image analyzing unit 14 acquires information concerning arrangement order of the acquired page images from the read image of the original document, the page images, the number-of-input-pages information, the information concerning arrangement position of the page images, and the information concerning arrangement order of the page images. The image analyzing unit 14 sends the information concerning arrangement order of the acquired page images to the storage control unit 15 on the basis of the page images and the number-of-input-pages information.

In Act 106, the storage control unit 15 causes the memory 802 to store the respective page images subjected to the image processing as separate page images in association with the number-of-input-pages information and the information concerning arrangement order of the page images. The storage control unit 15 notifies the editing-content acquiring unit 21 that the processing for storage of the page images in the memory 802 is performed.

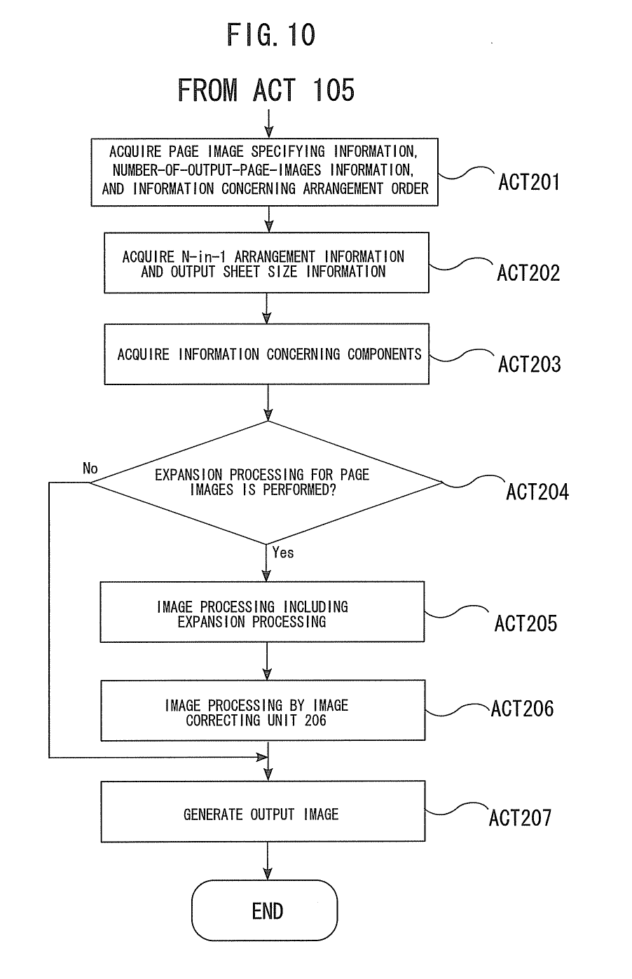

A processing flow concerning generation of an output image based on the stored page images in the MFP 101 according to the first embodiment is explained with reference to FIG. 10.

First, in Act 201, the editing-content acquiring unit 21 acquires page image specifying information, number-of-output-page-images information, and information concerning arrangement order of page images to be edited or maintained. Specifically, when the editing-content acquiring unit 21 acquires notification for notifying that respective plural images are stored in the memory 802 as separate page images, the editing-content acquiring unit 21 forms, using the page images stored in the memory 802, thumbnail images of the page images. Subsequently, the editing-content acquiring unit 21 forms, using the thumbnail images and the information concerning arrangement order of page images, a page image display screen for displaying an overview of the stored page images and causes the display 803 to display the page image display screen. The editing-content acquiring unit 21 acquires, using the page image display screen, the page image specifying information, the number-of-output-page-images information, and the information concerning arrangement order of page images to be edited or maintained.

In Act 202, the editing-content acquiring unit 21 acquires N-in-1 arrangement information and output sheet size information. Specifically, the editing-content acquiring unit 21 forms an output image setting screen shown in FIG. 7 according to the number-of-output-page-images information and causes the display 803 to display the output image setting screen. The editing-content acquiring unit 21 acquires, using the output image setting screen, the N-in-1 arrangement information and the output sheet size information.

The editing-content acquiring unit 21 sends the acquired page image specifying information, number-of-output-page-images information, N-in-1 arrangement information, output sheet size information, and information concerning arrangement order of page images to be edited or maintained to the component analyzing unit 23 and the editing processing unit 25 as editing content information.

In Act 203, the component analyzing unit 23 acquires information concerning components. Specifically, the component analyzing unit 23 acquires, on the basis of the page image specifying information, one or more page images designated in the page image specifying information from the memory 802 and executes analysis of components of the respective page images. The component analyzing unit 23 acquires, on the basis of a result of the analysis, information concerning the components of the one or more page images. The component analyzing unit 23 sends the information concerning the components to the image correcting unit 26.

In Act 204, first, the editing processing unit 25 determines, on the basis of the number-of-output-page-images information, the number-of-input-pages information, and the N-in-1 arrangement information, whether image processing including expansion processing should be applied to the acquired page images. If it is determined that the expansion processing is not performed (No in Act 204), the editing processing unit 25 sends the page images to the output-image generating unit 27 without applying the image processing to the page images.

On the other hand, if it is determined that the expansion processing is performed (Yes in Act 204), in Act 205, the editing processing unit 25 applies the image processing including the expansion processing to the page images on the basis of the number-of-input-pages information and the editing content information. The editing processing unit 25 sends the page images subjected to the image processing including the expansion processing to the image correcting unit 26 together with the editing content information and the number-of-input-pages information.

In Act 206, the image correcting unit 26 applies, on the basis of the information concerning the components, the number-of-input-pages information, and the editing content information, processing for performing image output improvement such as character smoothing processing, edge enhancement processing, filter processing, y correction processing, histogram processing, or identification processing to the acquired page images. Subsequently, the editing processing unit 25 sends the page images subjected to the image processing to the output-image generating unit 27.

In Act 207, the output-image generating unit 27 executes generation of an output image from the acquired page images on the basis of the editing content information.

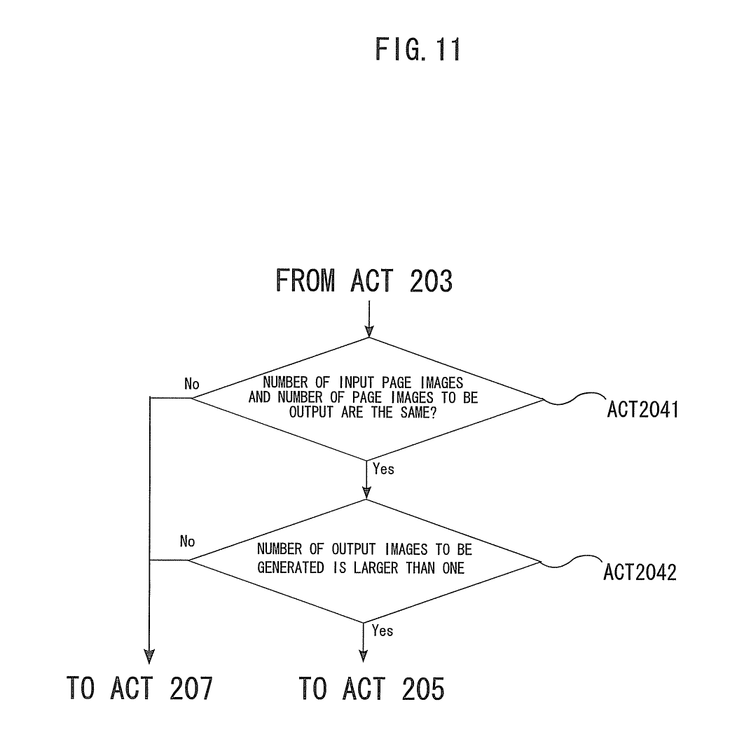

The determination concerning whether the image processing in the editing processing unit 25 should be performed is explained in detail with reference to FIG. 11.

First, in Act 2041, the editing processing unit 25 determines, according to the number-of-output-page-images information and the number-of-input-pages information, whether the number of page images stored in the memory 802 and the number of page images N-in-1-arranged in an output image are the same.

If the number of stored page images and the number of page images N-in-1-arranged in an output image are not the same (No in Act 2041), the editing processing unit 25 proceeds to Act 205 and applies the image processing including the expansion processing to the page images to be output.

On the other hand, if the number of stored page images and the number of page images N-in-1-arranged in an output image are the same (Yes in Act 2041), the editing processing unit 25 proceeds to Act 2042 and determines, according to the N-in-1 arrangement information and the number-of-output-page-images information, whether the number of output images generated by the output-image generating unit 27 is one.

If the number of output images to be generated is larger than one, a component scaling factor in the output images is larger than a component scaling factor of corresponding page images in a document image. Specifically, if the number of output images to be generated is larger than one (Yes in Act 2042), in Act 205, the editing processing unit 25 applies the image processing including the expansion processing to the page images to be output.

On the other hand, if the number of output images to be generated is one, the output image has components same as those of the read original document. Specifically, if the number of output images to be generated is one (No in Act 2042), the editing processing unit 25 sends the page images to the output-image generating unit 27 without applying the image processing to the page images (to Act 207).

### Second Embodiment

In the first embodiment, the MFP 101 applies the image processing to the acquired page images on the basis of the number-of-input-pages information and the editing content information.

In addition to the configuration, the MFP 101 according to a second embodiment of the present invention is configured to change, according to number-of-input-pages information, the resolution of scanning for an original document including page images.

Since the MFP 101 according to the second embodiment is configured as explained above, with the MFP 101, it is possible to further suppress the shapes of components from being deformed by expansion processing for page images.

Functional blocks concerning storage of page images and editing of an output image in the MFP 101 according to the second embodiment is explained. Functional blocks same as those in the first embodiment are denoted by the same reference numerals and explanation of the functional blocks is omitted.

The number-of-pages-information acquiring unit 11 forms an input screen for the number of page images as in the first embodiment and causes the display 803 to display the input screen. Subsequently, the number-of-pages-information acquiring unit 11 acquires number-of-input-pages information using the input screen. In the second embodiment, the number-of-pages-information acquiring unit 11 sends the acquired number-of-input-pages information to the image-information acquiring unit 12 in addition to the image processing unit 13.

The image-information acquiring unit 12 causes the image reading unit R to read image areas corresponding to respective plural page images on a read image of an original document in a state in which an image reading condition based on the number-of-input-pages information acquired by the number-of-pages-information acquiring unit 11 is applied to the reading. For example, the image-information acquiring unit 12 causes the image reading unit R to scan a reading target original document at resolution corresponding to the number-of-input-pages information acquired by the number-of-pages-information acquiring unit 11. When the number-of-input-pages information is larger than a predetermined number, the image-information acquiring unit 12 can cause the image reading unit R to scan the original document at resolution higher than resolution of scanning performed when the number-of-input-pages information is larger than the predetermined number.

A rate for increasing the resolution is not specifically limited. Those skilled in the art can arbitrarily set the rate. For example, information concerning the number of page images included in an original document and information concerning the level of resolution may be stored in the memory 802 in advance in association with each other. When the number of page images is a number within a predetermined range, the image-information acquiring unit 12 can control, using these kinds of information, the image reading unit R to perform scanning at specific resolution.

Subsequently, the image-information acquiring unit 12 acquires image data of a read image of the original document from the image reading unit R and sends the image data to the image processing unit 13 and the image analyzing unit 14.

In other words, in the second embodiment, the image-information acquiring unit 12 is equivalent to the scan control unit of the present invention.

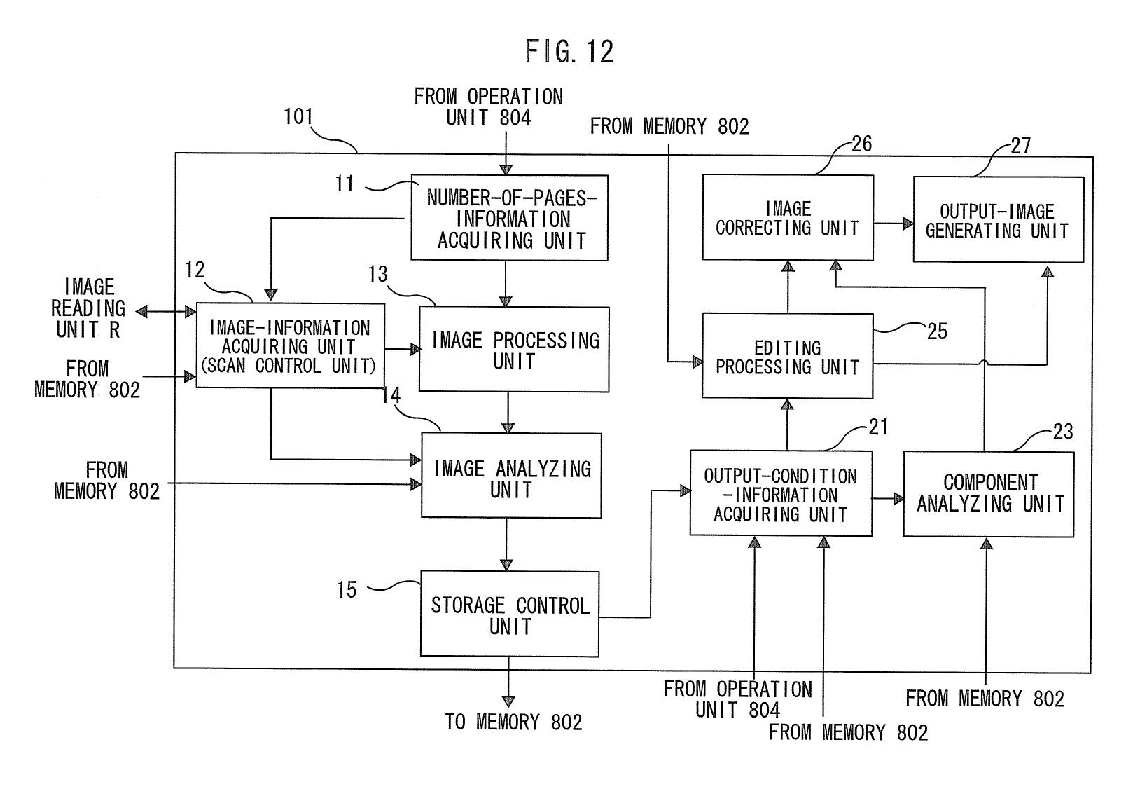

A processing flow for storing, as separate images, plural page images included in an original document according to the second embodiment is explained in detail with reference to FIG. 12. A processing flow concerning generation of an output image based on stored page images in the second embodiment is the same as that in the first embodiment. Therefore, explanation of the processing flow is omitted. In the processing flow shown in FIG. 12, Act 301 and Act 305 to Act 308 are respectively the same as Act 101 and Act 103 to Act 106 in the first embodiment. Therefore, explanation of the acts is omitted.

In the following explanation, resolutions in two stages are stored in the memory 802 and the scan control unit 12 causes the image reading unit R to perform reading processing at the lower resolution in advance. The scan control unit 12 causes the image reading unit R to perform reading processing at the higher resolution when the number of page images is larger than a predetermined number.

In Act 302, the number-of-pages-information acquiring unit 11 forms the input screen for the number of page images shown in FIG. 5 and causes the display 803 to display the input screen. Subsequently, the number-of-pages-information acquiring unit 11 acquires, using the input screen for the number of page images, number-of-input-pages information indicating the number of arrayed pages of plural page images arrayed on a reading target original document. The number-of-pages-information acquiring unit 11 sends the acquired number-of-input-pages information to the image processing unit 13. The number-of-pages-information acquiring unit 11 notifies the image-information acquiring unit 12 that a request for the start of storage of page images and editing processing for an output image is acquired and sends the acquired number-of-input-pages information to the image-information acquiring unit 12.

In Act 303, the image-information acquiring unit 12 determines, on the basis of the acquired number-of-input-pages information, whether the number of page images is larger than the predetermined number. If the number of page images is equal to or smaller than the predetermined number (No in Act 303), the image-information acquiring unit 12 does not execute control for changing resolution in scanning for the image reading unit R (to Act 305). On the other hand, if the number of page images is larger than the predetermined number (Yes in Act 303), in Act 304, the image-information acquiring unit 12 controls the image reading unit R to increase the resolution in scanning.

### Third Embodiment

The MFP 101 according to a third embodiment of the present invention executes, when N-in-1 arrangement is performed and printing is executed on the basis of operation input of a user, editing concerning the arrangement and the size of each of plural page images to be printed on a sheet.

More specifically, when plural page images are arranged to be output to a sheet in N-in-1 arrangement, in some cases, the number of page images per one page is smaller than a predetermined number. In the third embodiment, a page image corresponding to a page in which the number of page images is smaller than the predetermined number (hereinafter referred to as excess page image) is moved to a page having a page number adjacent to that of the page, for example, a page having a page number smaller than that of the page by one. In the following explanation, a page having a page number smaller than a certain page number of a page is referred to as the preceding page.

First, functional blocks concerning the movement of the excess page to the preceding page in the third embodiment are explained.

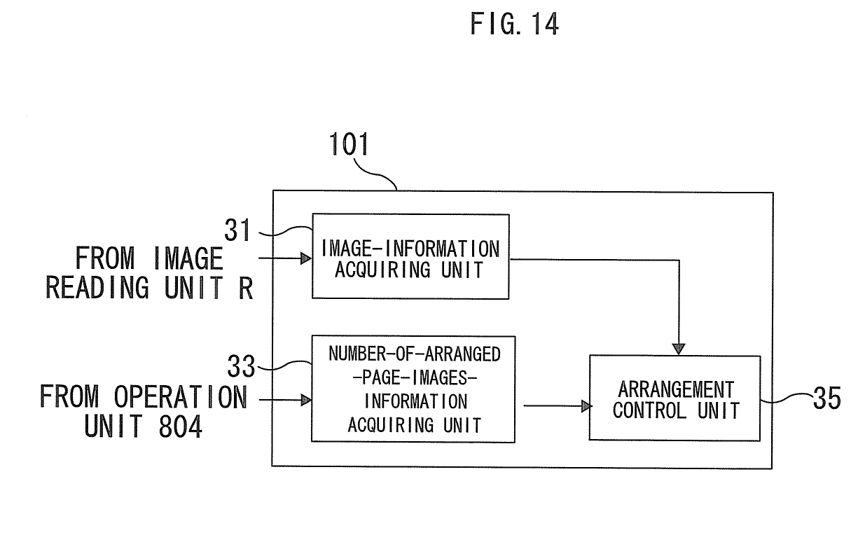

As shown in FIG. 14, the MFP 101 according to the third embodiment includes an image-information acquiring unit 31, a number-of-arranged-page-images-information acquiring unit 33, and an arrangement control unit 35.

The image-information acquiring unit 31 acquires image data of plural page images as a target of N-in-1 arrangement. The image data of the plural page images may be image data of an original document read by the image reading unit R or may be image data acquired by the MFP 101 via a network. The image-information acquiring unit 31 sends the acquired image data of the plural page images to the arrangement control unit 35.

The number-of-arranged-page-images-information acquiring unit 33 acquires information concerning the number of arranged page images indicating how many of plural page images as arrangement targets are arranged per one page (equivalent to the N-in-1 arrangement information in the first embodiment). The information concerning the number of arranged page images may be input from the user via the operation unit 804 or may be acquired via the network in the same manner as the image data. The number-of-arranged-page-images information acquiring unit 33 sends the acquired information concerning the number of arranged page images to the arrangement control unit 35.

If there is a page in which the number of page images per one page is smaller than a predetermined number when plural page images acquired by the image-information acquiring unit 31 are N-in-1-arranged according to the information concerning the number of arranged page images acquired by the number-of-arranged-page-images-information acquiring unit 33, the arrangement control unit 35 moves an excess page image corresponding to the page in which the number of page images is smaller than the predetermined number to a page having a page number adjacent to that of the page, for example, the preceding page.

An example of the movement of the excess page image to the preceding page is specifically explained.

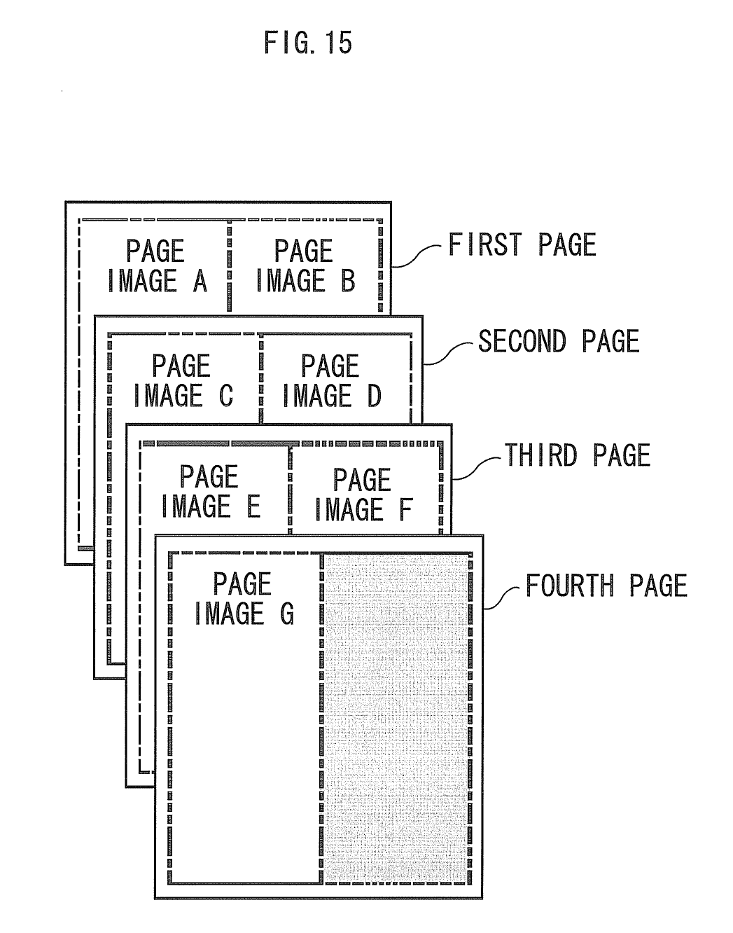

For example, it is assumed that seven page images (page images A to G) are output in a 2-in-1 output format shown in FIG. 15. The predetermined number of page images per one page used by the arrangement control unit 35 to determine whether images including an excess page image are generated is two. First, the arrangement control unit 35 counts the number of acquired page images and obtains information concerning the number of page images to be output.

Subsequently, the arrangement control unit 35 determines, according to the information concerning the number of page images to be output and the information concerning the number of arranged page images, that there is a page including an excess page image when the page images are output. When the page images A to G are output in 2-in-1 arrangement, as shown in FIG. 15, the number of page images to be arranged is one in a fourth page in which a page image G is arranged. In such a case, the arrangement control unit 35 determines that there is a page in which an excess page image (the page image G) is arranged.

If it is determined that there is a page including an excess page image, the arrangement control unit 35 moves the excess page image to the preceding page having a page number smaller than that of the page corresponding to the excess page image by one. For example, the arrangement control unit 35 moves the page image G in the fourth page shown in FIG. 15 to a third page. First, the arrangement control unit 35 reduces a page image F arranged in the third page and rotates the page image F by 90 degrees. Subsequently, the arrangement control unit 35 reduces the page image G and rotates the page image G by 90 degrees to allocate the page image G to a vacant area in the third page formed by the reduction and the rotation of the page image. Basically, 90-degree rotation is performed to align directions of images. However, user designation for not performing rotation is also possible.

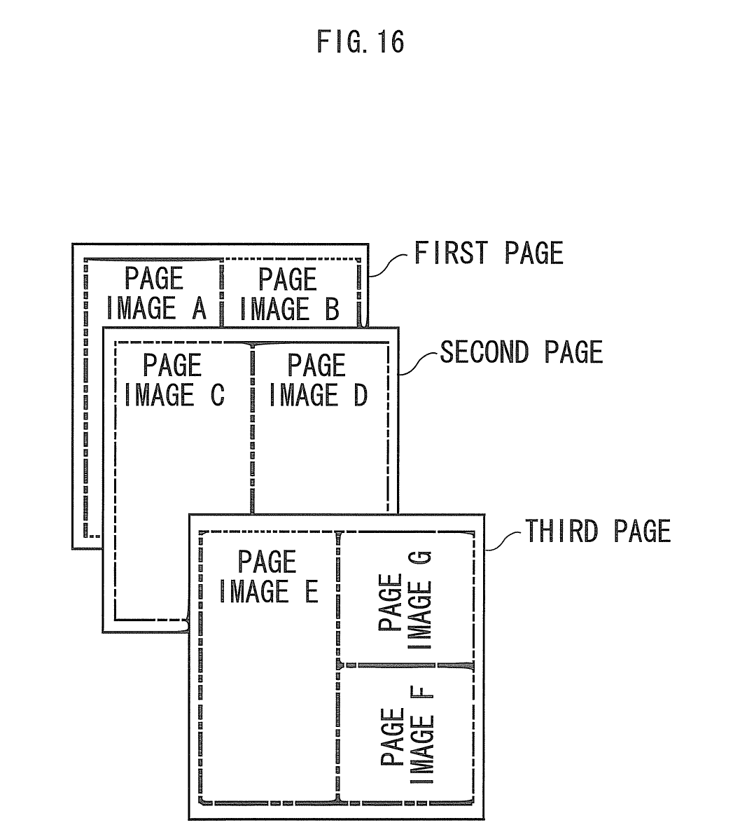

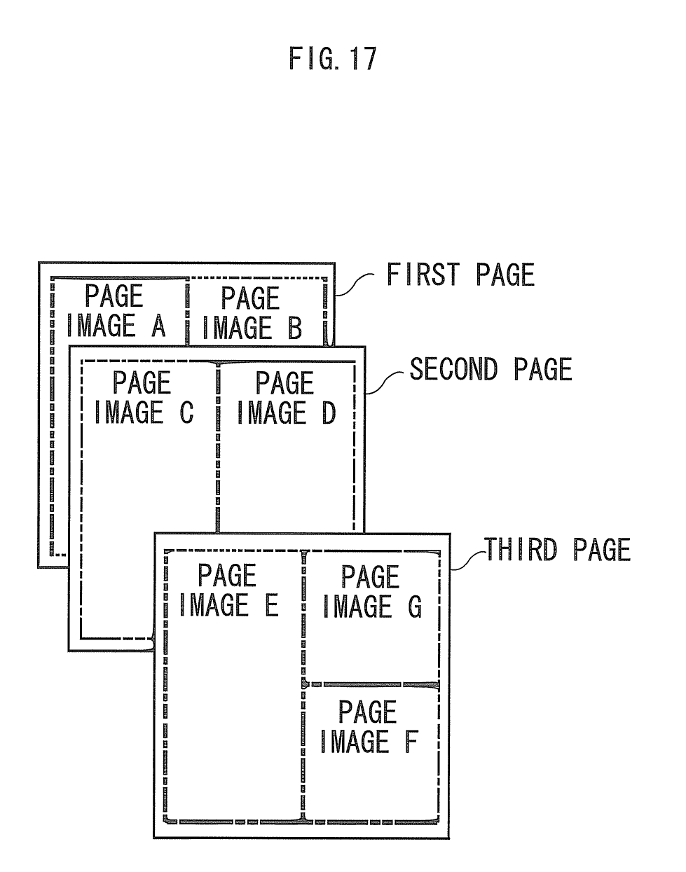

A schematic diagram of the output of the page images, arrangement of which is edited by the arrangement control unit 35 in this way, is shown in FIGS. 16 and 17. In FIG. 16, the excess page image is rotated and moved. In FIG. 17, the excess page image is moved without being rotated. As shown in FIGS. 16 and 17, page images equal to or larger than a predetermined number (e.g., two) are included in any one of sheets onto which page images are output. There is no page including an excess page image. Therefore, according to the third embodiment, it is possible to hold down an amount of consumption of sheets in the output of page images.

In the processing of N-in-1 arrangement, information concerning positions where page images are arranged on a sheet is stored in the memory 802 in association with a predetermined reference (e.g., order of page images to be acquired by the image reading unit R) (the information is hereinafter referred to as page image arrangement order information). The arrangement control unit 35 acquires, for example, the page image arrangement order information from the memory 802 and specifies a page image that is reduced and rotated according to the movement of an excess page image.

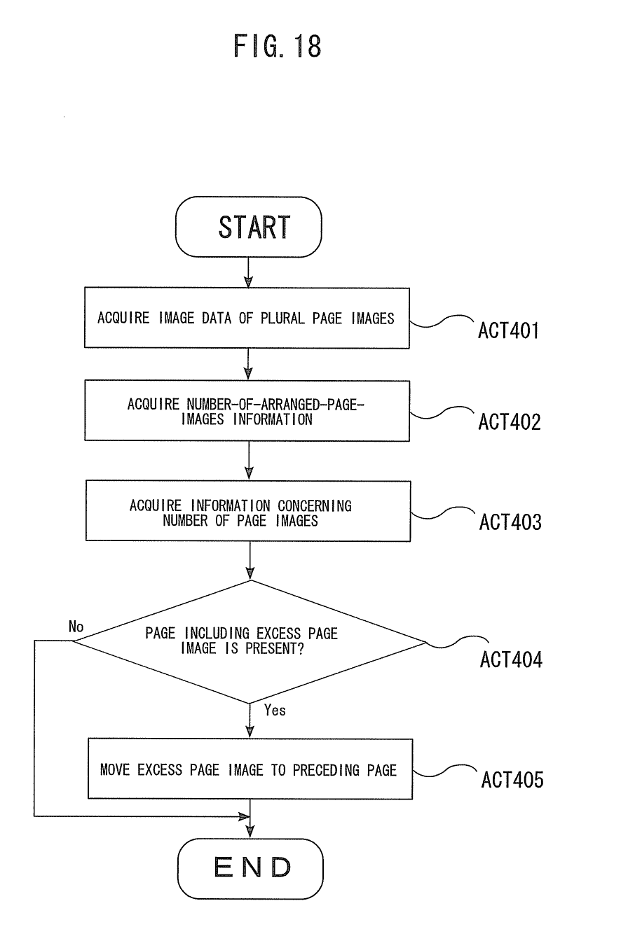

A processing flow concerning the movement of an excess page image to the preceding page is explained in detail below with reference to FIG. 18.

In Act 401, the image-information acquiring unit 31 acquires image data of plural page images set as targets of N-in-1 arrangement. The image-information acquiring unit 31 sends the acquired image data of the page images to the arrangement control unit 35.

Subsequently, in Act 402, the number-of-arranged-page-images-information acquiring unit 33 acquires information concerning the number of arranged page images indicating how many of the plural page images as the arrangement targets are arranged per one page. The number-of-arranged-page-images-information acquiring unit 33 sends the acquired information concerning the number of arranged page images to the arrangement control unit 35.

In Act 403, the arrangement control unit 35 counts acquired page images and acquires information concerning the number of page images.

In Act 404, the arrangement control unit 35 determines, according to the information concerning the number of page images and the information concerning the number of arranged page images, whether there is a page including an excess page image. If there is no page including an excess page image (No in Act 404), the arrangement control unit 35 ends the processing without performing the movement of an excess page image to the preceding page.

On the other hand, if it is determined that there is a page including an excess page image (Yes in Act 404), in Act 405, the arrangement control unit 35 moves the excess page image from the page including the excess page image to the preceding page.

### Fourth Embodiment

In the third embodiment, if there is a page including an excess page image when page images are N-in-1-arranged and output, the excess page image is moved to the preceding page. In a fourth embodiment of the present invention, the MFP 101 includes a configuration capable of moving, in addition to the movement of the excess page image to the preceding page, a page image arbitrarily selected by operation input of a user to a page having a page number adjacent to that of a page corresponding to the page image, for example, the preceding page.

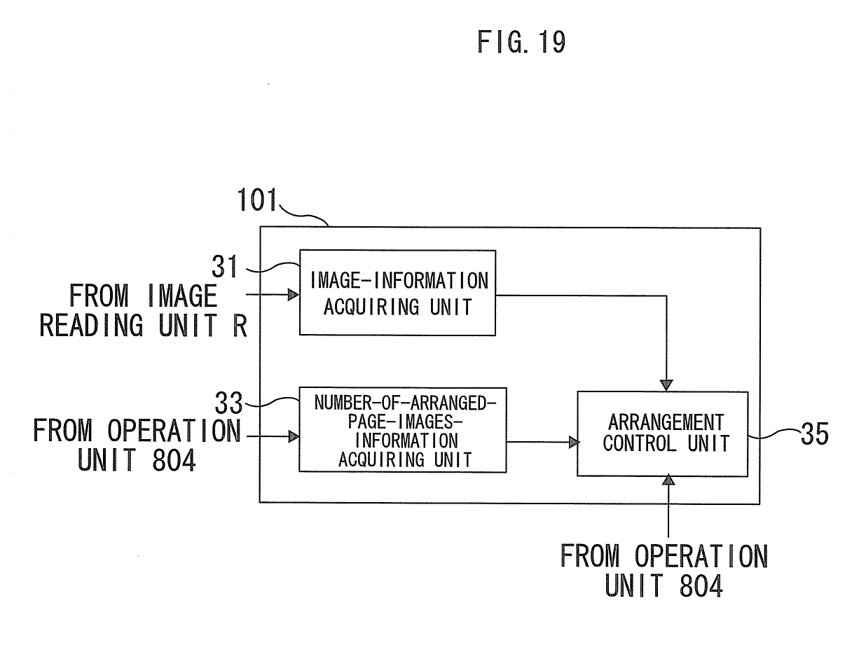

First, functional blocks concerning the movement of an excess page image to the preceding page is explained with reference to FIG. 19. Functional blocks same as those in the third embodiment are denoted by the same reference numerals and explanation of the functional blocks is omitted.

In the fourth embodiment, if it is determined that there is an excess page image according to the information concerning the number of acquired page images and information concerning the number of arranged page images, the arrangement control unit 35 forms a moving page image selection screen for selecting a page image to be moved other than the excess page image and causes the display 803 to display the moving page image selection screen. Specifically, the arrangement control unit 35 generates thumbnail images for the acquired page images and forms the moving page image selection screen using the thumbnail images.

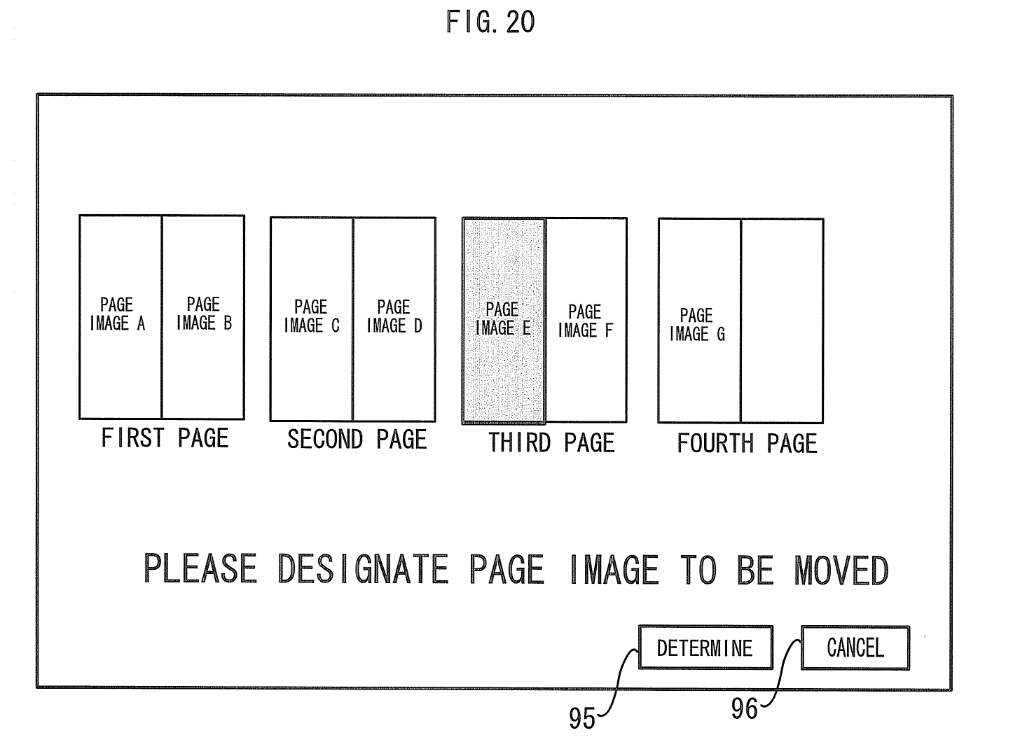

The moving page image selection screen is illustrated in FIG. 20. In FIG. 20, the user selects a page image different from an excess page to be moved and depresses a button 95 to input the selection. In the moving page image selection screen shown in FIG. 20, the selected page image can be displayed with, for example, hatching. Specifically, the arrangement control unit 35 acquires information concerning the page image to be moved using the moving page image selection screen. When the user selects an excess page image on the moving page image selection screen shown in FIG. 20 and the arrangement control unit 13 acquires information concerning the selection, the arrangement control unit 13 regards that no page image to be moved other than the excess page image is selected. A button 96 is a button for stopping output processing by N-in-1 arrangement.

In the fourth embodiment, the arrangement control unit 35 moves the excess page image to the preceding page using the information concerning the selection of a page image to be moved based on operation input of the user acquired in this way.

For example, in some cases, a page image G as an excess page image is selected on the moving page image selection screen shown in FIG. 20. In such a case, the arrangement control unit 35 moves, according to processing same as the processing in the third embodiment, the page image G as the excess page image included in a fourth page to a third page as the preceding page.

On the other hand, in some cases, a page image different from the excess page image is selected on the moving page image selection screen shown in FIG. 19. For example, a page image F is selected. First, the arrangement control unit 31 moves the page image E to a second page that is the preceding page of the third page including the page image E.

In the movement of the page image E, first, the arrangement control unit 35 reduces a page image D included in the second page and rotates the page image D by 90 degrees on the basis of page image arrangement order information. Subsequently, the arrangement control unit 35 reduces the page image E and rotates the page image E by 90 degrees to allocate the page image E to a vacant area formed by the reduction and the rotation of the page image D. Basically, 90-degree rotation is performed to align directions of images. However, user designation for not performing rotation is also possible.

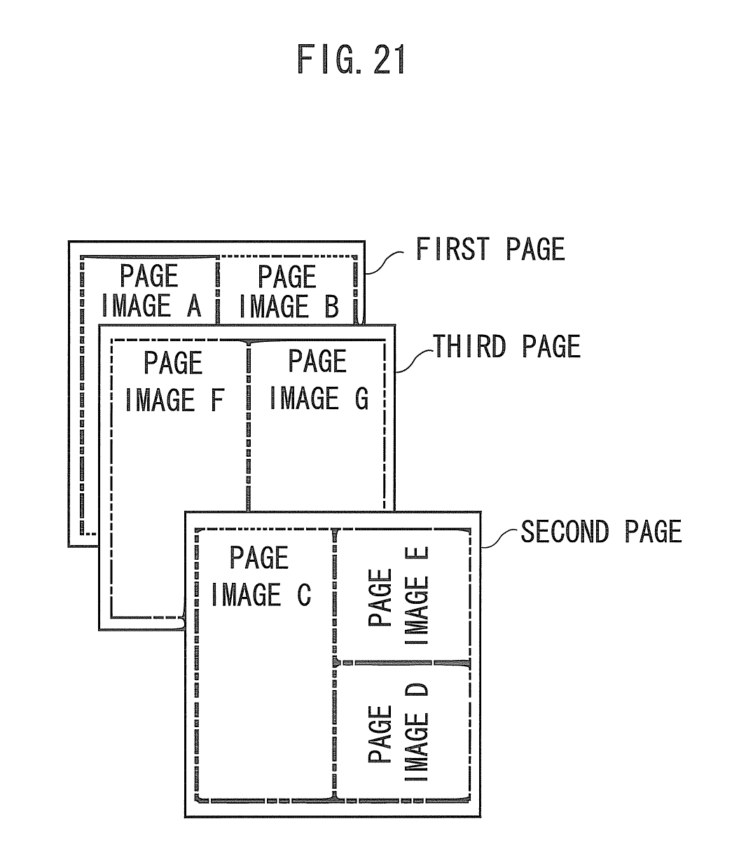

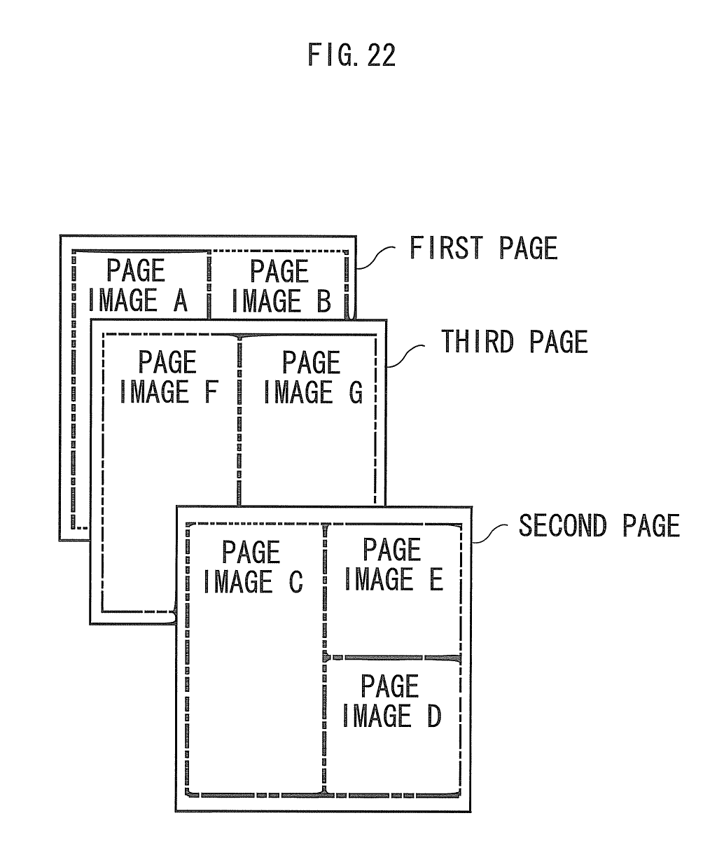

The arrangement control unit 35 moves a page image F to a vacant area in the third page formed by the movement of the page image E on the basis of the page image arrangement order information. The arrangement control unit 35 allocates the page image G as the excess page image to a vacant area in the third page formed by the movement of the page image F. Plural output images generated at this point are illustrated in FIGS. 21 and 22. In FIG. 21, the excess page image is rotated and moved. In FIG. 22, the excess page image is moved without being rotated.

Therefore, according to the fourth embodiment, in moving the excess page image to the preceding page, the user can set the page images in arrangement more suitable for the preference of the user. When the page images other than the excess page images are moved as explained above, if the number of page images and the number of excess page images are the same or the number of page images is larger than the number of excess page images, the excess page images are not reduced in size.

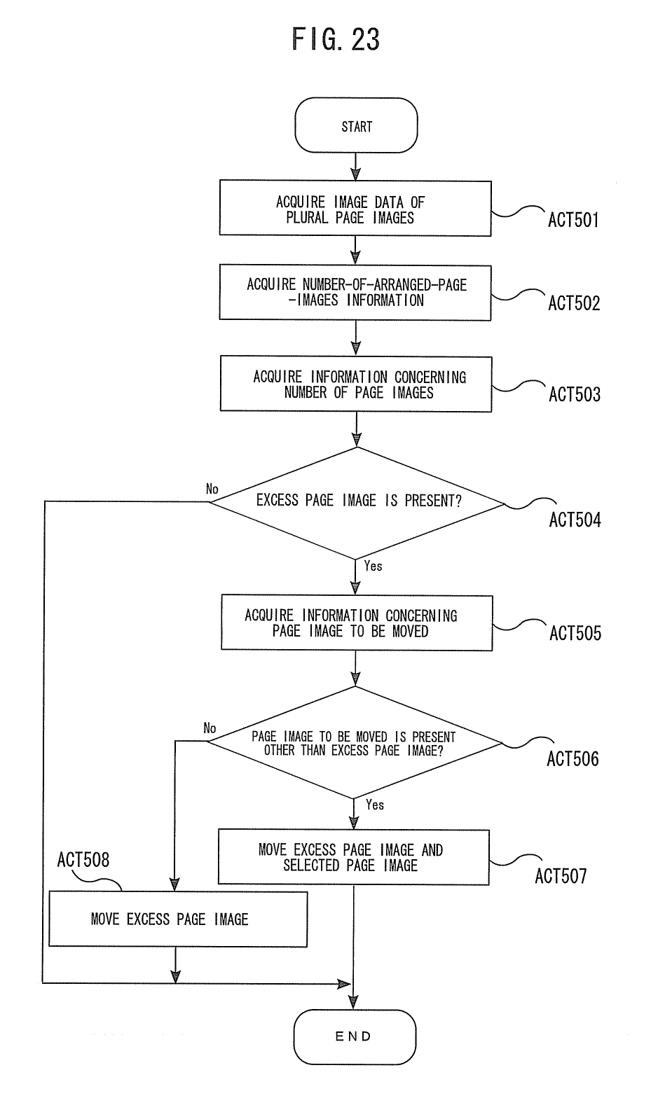

A processing flow concerning movement of an excess page image to the preceding page in the fourth embodiment is explained with reference to FIG. 23. Act 501 to Act 504 are the same as Act 401 to Act 404 in the third embodiment. Therefore, explanation of the acts is omitted.

In Act 505, the arrangement control unit 35 acquires information concerning a page image to be moved other than an excess page image using the moving page image selection screen.

In Act 506, the arrangement control unit 35 determines, according to the acquired information concerning a page image to be moved, whether there is a page image to be moved other than the excess page image. If there is a page image to be moved other than the excess page image (Yes in Act 506), in Act 507, the arrangement control unit 35 selects the page image and moves the excess page image and the selected page image to the preceding page.

On the other hand, if it is determined that there is no page image to be moved other than the excess page image (No in Act 506), in Act 508, the arrangement control unit 35 moves the excess page image to the preceding page.

### Other Embodiments

The embodiments of the present invention are explained above. However, the present invention is not limited to the embodiments. Other embodiments can be adopted.

For example, in the first and second embodiments, arraying order of stored page images can be arbitrarily set. Specifically, in the present invention, since the page images are stored in the storage area as separate images, the page images can be rearranged in arbitrarily-selected order.

In the first and second embodiment, the page images are stored in the memory 802. However, the present invention is not limited to this. For example, the page images can be stored in an external storage area connected to the MFP 101 via a network.

In the first and second embodiment, the image processing unit 13 applies the image processing to the sliced separate page images. However, the image processing unit 13 may apply the image processing to the read image of the original document. Specifically, the image processing unit 13 applies the image processing to the image areas corresponding to the respective plural page images on the read image of the original document on the basis of the number-of-input-pages information acquired by the number-of-pages-information acquiring unit 11. The storage control unit 15 causes the memory 802 to store, as separate page images, the image areas corresponding to the respective plural page images processed by the image processing unit 13.

The MFP 101 may include any one of the image processing unit 13, the editing processing unit 25, and the image correcting unit 26.

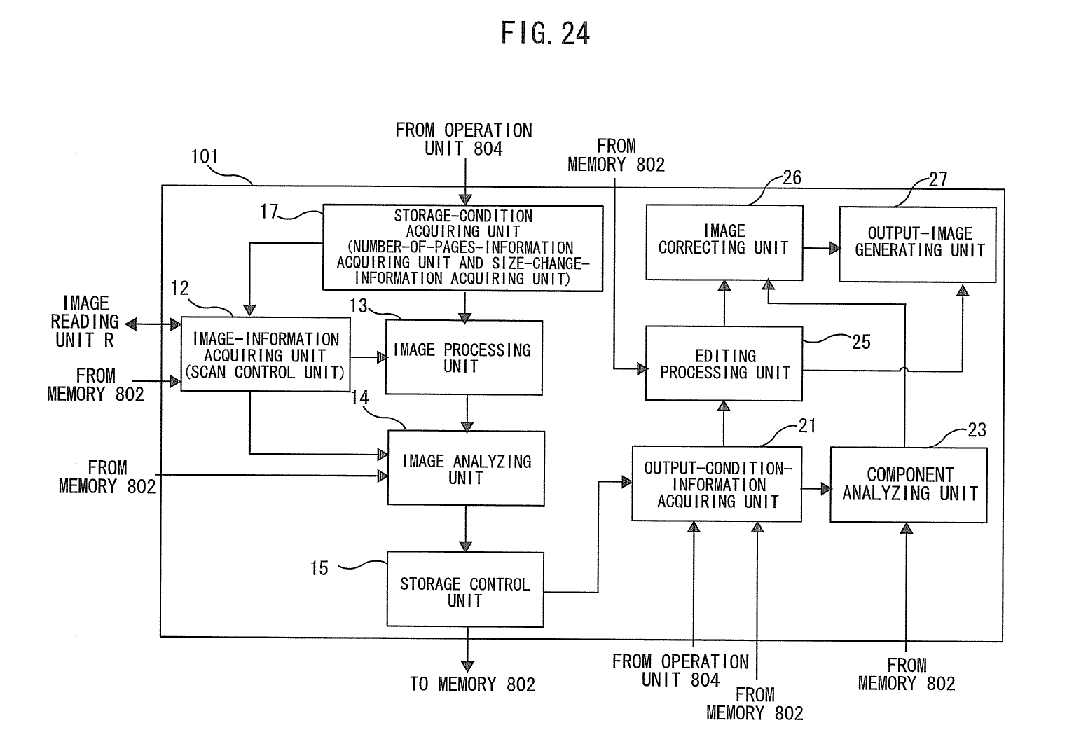

In addition, in the first embodiment, the image processing unit 13 applies the image processing based on the number-of-input-pages information. In the second embodiment, the image-information acquiring unit 12 causes the image reading unit R to perform scanning in a state in which an image reading condition corresponding to the number-of-input-pages information is applied to the scanning. Image processing and/or scan control based on, in addition to the number-of-input-pages information, interim size information as information concerning size change processing assumed to be applied based on operation input of the user may be performed. Functional blocks of the configuration are shown in FIG. 24.

The MFP 101 includes a storage-condition acquiring unit 17 in addition to the functional blocks explained in the second embodiment.

The storage-condition acquiring unit 17 acquires the number-of-input-pages information and acquires, on the basis of operation input of the user, interim size change information concerning size change processing assumed to be applied to the page images stored in the predetermined storage area.

In other words, the storage-condition acquiring unit 17 is equivalent to the number-of-pages-information acquiring unit and the size-change-information acquiring unit.

The interim size change information can be, for example, the number of page images to be output assumed by the user at an input point (interim number-of-output-page-images information) and/or the size of a sheet to be output (interim output sheet size information).

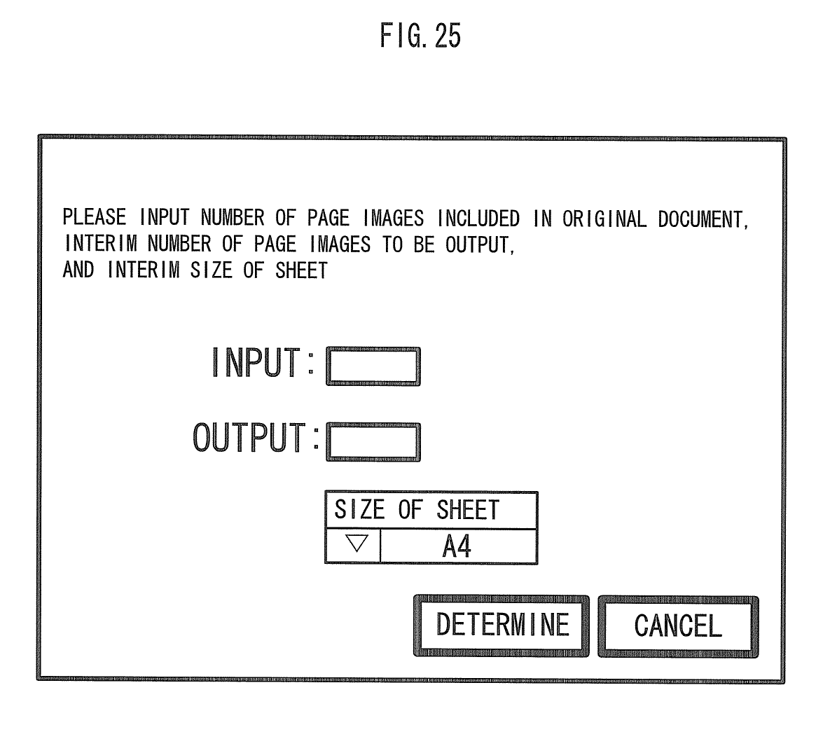

As shown in FIG. 25, the interim size change information can be acquired on the basis of operation of the user together with, for example, the number-of-input-pages information.

In the explanation of the first and second embodiments, the page images included in the image of the original document have the same size. However, the present invention is not limited to this and can be applied even when the sizes of the page images are different. In this case, for example, it is also possible to display the acquired image of the original document on the display 803 and specify a page image on the basis of designation by the user.

The arrangement control unit 35 explained in the third and fourth embodiments may be capable of interchanging the positions of the page images in a page at a moving destination (the preceding page) according to components of the excess page image to be moved. In this case, the arrangement control unit 35 executes analysis of components of the acquired page images and acquires information concerning the components. Subsequently, the arrangement control unit 35 performs replacement of the page images on the basis of the acquired information concerning the components. For example, when an excess page image includes only photographs and a page image reduced by the movement of the excess page image to the preceding page also includes photographs, these page images may be replaced with a page image including only characters as components in the preceding page.

In the third and fourth embodiments, when the excess page is moved to the preceding page, the arrangement control unit 35 arranges the excess page image and the page image reduced according to the movement after rotating the page images by 90 degrees. However, the present invention is not limited to the embodiment. It is also possible to cause the arrangement control unit 35 to perform only reduction processing for these images and not to rotate the images. The arrangement control unit 35 may determine whether the rotation is performed according to components in the page images. For example, when the page image to be reduced includes characters as components, these page images can be arranged without being rotated.

In the third and fourth embodiments, the arrangement control unit 35 specifies another page image to be reduced and rotated according to the movement of the excess page image on the basis of the page image array order information. However, it is also possible to adopt other forms. For example, the user may be capable of selecting another page image to be reduced and rotated.

In the third and fourth embodiments, the excess page image is moved to the preceding page. However, the excess page image may be moved to a page having a page number larger than a page corresponding to the excess page image by one.

In the embodiments explained above, the component scaling factor in the output image of the page images is set according to, for example, a type of a sheet to be output. However, the user may be capable of setting the component scaling factor. In this case, for example, it is possible to perform display of output image component images such as thumbnails and cause the user to designate the component scaling factor.

A computer program for causing a computer included in the MFP 101 to execute the operations explained above can be provided as a page image managing program. In the example explained in the first to fourth embodiments, the computer program for realizing the function of carrying out the invention is recorded in advance in the storage area provided in the MFP 101. However, the present invention is not limited to this. The same computer program may be downloaded to the apparatus from the network or the same program stored in a computer-readable recording medium may be installed in the apparatus. The recording medium may be a recording medium of any form as long as the recording medium can store a computer program and can be read by the computer. Specifically, examples of the recording medium include internal storage devices internally mounted in the computer such as a ROM and a RAM, portable storage media such as a CD-ROM, a flexible disk, a DVD disk, a magneto-optical disk, and an IC card, a database that stores a computer program, another computer and a database thereof, and a transmission medium on a line. The function obtained by installation or download in advance in this way may be a function realized in cooperation with an OS (operating system) in the apparatus.

The computer program in this embodiment includes a computer program in which an execution module is dynamically generated.

The present invention is explained above in detail with reference to the specific embodiments. However, it would be apparent to those skilled in the art that various modifications and alterations can be made without departing from the spirit and the scope of the present invention.

According to the present invention, it is possible to perform editing of an array, a component scaling factor, and the like of N-in-1 -arranged page images.

What is claimed is:

1. A page image managing apparatus comprising:
a number-of-pages-information acquiring unit configured to acquire number-of-input-pages information indicating a number of arrayed pages of plural page images arrayed in a reading target original document;
an image processing unit configured to slice, on the basis of the number-of-input-pages information acquired by the number-of-pages-information acquiring unit, the plural page images from a read image of the original document and apply image processing corresponding to the number-of-input-pages information acquired by the number-of-pages-information acquiring unit to the respective sliced page images; and
a storage control unit configured to cause a predetermined storage area to store the respective plural page images processed by the image processing unit as separate page images.

2. The apparatus according to claim 1, further comprising:
an editing processing unit configured to apply, on the basis of operation input of a user, editing processing including size change processing to the page images stored in the predetermined storage area; and
an image correcting unit configured to apply image processing corresponding to the number-of-input-pages information acquired by the number-of-pages-information acquiring unit and the size change processing applied by the editing processing unit to the page images subjected to the editing processing by the editing processing unit.

3. The apparatus according to claim 1, further comprising a size-change-information acquiring unit configured to acquire, on the basis of operation input of a user, interim size change information concerning size change processing assumed to be applied to the page images stored in the predetermined storage area, wherein
the image processing unit applies image processing corresponding to the number-of-input-pages information acquired by the number-of-pages-information acquiring unit and the interim size change information acquired by the size-change-information acquiring unit to the respective plural page images sliced from the read image of the original document on the basis of the number-of-input-pages information acquired by the number-of-pages-information acquiring unit.

4. The apparatus according to claim 1, further comprising a scan control unit configured to cause an image reading unit to read, in reading the original document, image areas corresponding to the respective plural page images on the read image of the original document in a state in which an image reading condition based on the number-of-input-pages information acquired by the number-of-pages-information acquiring unit is applied to the reading.

5. The apparatus according to claim 1, further comprising:
a size-change-information acquiring unit configured to acquire, on the basis of operation input of a user, interim size change information concerning size change processing assumed to be applied to the page images stored in the predetermined storage area; and
a scan control unit configured to cause an image reading unit to read, in reading the original document, image areas corresponding to the respective plural page images on the read image of the original document in a state in which an image reading condition based on the number-of-input-pages information acquired by the number-of-pages-information acquiring unit and the interim size change information acquired by the size-change-information acquiring unit is applied to the reading.

6. An image managing apparatus comprising:
a number-of-pages-information acquiring unit configured to acquire number-of-input-pages information indicating a number of arrayed pages of editing target plural page images in an original document on which the plural page images are arrayed;
an editing processing unit configured to apply editing processing including size change processing based on operation input of a user to the plural page images sliced from a read image of the original document and stored in a predetermined storage area; and
an image correcting unit configured to apply image processing corresponding to the number-of-input-pages information acquired by the number-of-pages-information acquiring unit and the size change processing applied by the editing processing unit to the page images subjected to the editing processing by the editing processing unit.

7. The apparatus according to claim 6, further comprising:
an image processing unit configured to slice, on the basis of the number-of-input-pages information acquired by the number-of-pages-information acquiring unit, the plural page images from the read image of the original document and apply image processing corresponding to the number-of-input-pages information acquired by the number-of-pages-information acquiring unit to the respective sliced plural page images; and
a storage control unit configured to cause a predetermined storage area to store the respective plural page images processed by the image processing unit as separate page images.

8. The apparatus according to claim 6, further comprising a scan control unit configured to cause an image reading unit to read, in reading the original document, image areas corresponding to the respective plural page images on the read image of the original document in a state in which an image reading condition based on the number-of-input-pages information acquired by the number-of-pages-information acquiring unit is applied to the reading.

9. The apparatus according to claim 6, further comprising:
a size-change-information acquiring unit configured to acquire, on the basis of operation input of a user, interim size change information concerning size change processing assumed to be applied to the page images stored in the predetermined storage area; and
a scan control unit configured to cause an image reading unit to read, in reading the original document, image areas corresponding to the respective plural page images on the read image of the original document in a state in which an image reading condition based on the number-of-input-pages information acquired by the number-of-pages-information acquiring unit and the interim size change information acquired by the size-change-information acquiring unit is applied to the reading.

10. A page image managing apparatus comprising:
an image-information acquiring unit configured to acquire information concerning plural page images set as targets of N-in-1 arrangement;
a number-of-arranged-page-images-information acquiring unit configured to acquire information concerning a number of arranged page images indicating how many of the plural page images as the arrangement targets are arranged per one page; and
an arrangement control unit configured to move, when there is a page in which the number of page images per one page is smaller than a predetermined number if the plural page images acquired by the image-information acquiring unit are arranged according to the information concerning the number of arranged page images acquired by the number-of-arranged-page-images-information acquiring unit, an excess page image corresponding to the page, in which the number of page images is smaller than the predetermined number, to a page having a page number adjacent to a page number of the page.

11. The apparatus according to claim 10, wherein the arrangement control unit allocates, in a state in which the excess page image is reduced and rotated by 90 degrees, the excess page image to a vacant area formed by reducing and rotating by 90 degrees any one of the page images N-in-1-arranged on a page at a moving destination that is a page to which the excess page image should be moved.

12. The apparatus according to claim 10, wherein the movement of the excess page image to the page having the page number adjacent to that of the page corresponding to the excess page image by the arrangement control unit can be executed together with movement of a page image arbitrarily selected by operation input of a user to a page having a page number adjacent to that of a page corresponding to the page image.

13. The apparatus according to claim 10, wherein the arrangement control unit interchanges positions of page images in the page having the adjacent page number according to components included in the excess page image.
